(19) United States
(12) Patent Application Publication
(10) Pub. No.: US 2026/0089461 A1
(43) Pub. Date: Mar. 26, 2026

(54) RENDERING OF REVERBERATION WITH CONFIGURABLE INITIAL CHARACTERISTICS

(71) Applicant: Nokia Technologies Oy, Espoo (FI)

(72) Inventors: Antti Johannes ERONEN, Tampere (FI); Michael Thomas MCCREA, Helsinki (FI); Archontis POLITIS, Tampere (FI)

(21) Appl. No.: 18/893,330

(22) Filed: Sep. 23, 2024

(51) Int. Cl. H04S 7/00

(52) U.S. Cl. CPC H04S 7/305

(57) ABSTRACT

An apparatus comprising at least one processor and at least one memory storing instructions that, when executed by the at least one processor, cause the system at least to perform: obtaining the at least one audio signal; obtaining at least three reverberation parameters based on obtaining reverberation configuration information and directional configuration information; controlling a reverberator using the at least three reverberation parameters for providing a reverberant audio signal using the at least one audio signal, based on the at least three reverberation parameters, the reverberant audio signal comprising at least a late reverberation part; processing at least a portion of the reverberant audio signal, the portion of the reverberant audio signal at least partially interfering with a reflection audio signal; and generating a binaural output audio signal, the binaural output audio signal comprising the processed reverberant audio signal.

### FIELD

The present application relates to apparatus and methods for rendering of reverberation with configurable initial characteristics, but not exclusively for rendering of reverberation with configurable initial characteristics in augmented reality and/or virtual reality apparatus.

### BACKGROUND

Reverberation refers to the persistence of sound in a space after an actual sound source has stopped. Different spaces are characterized by different reverberation characteristics. For conveying spatial impression of an environment, reproducing reverberation perceptually accurately is important. Room acoustics are often modelled with an individually synthesized early reflection portion and a statistical model for the diffuse late reverberation. FIG. 1 depicts an example of a synthesized room impulse response where the direct sound 101 is followed by discrete early reflections 103 (or reflection echoes) which have a direction of arrival (DOA) and diffuse late reverberation 107 which can be synthesized without any specific direction of arrival. The delay d1(t) 102 in FIG. 1 can be seen to denote the direct sound arrival delay from the source to the listener. Furthermore the delay d2(t) 104 can denote the delay from the source to the listener for one of the early reflections (in this case the first arriving reflection). Additionally the delay d3(t) 106 can denote the delay from the source the onset of the diffuse late reverberation.

One method of reproducing reverberation is to utilize a set of D loudspeakers (or virtual loudspeakers reproduced binaurally using a set of head-related transfer functions (HRTFs)). The loudspeakers are positioned around the listener somewhat evenly. Mutually incoherent reverberant signals are reproduced from these loudspeakers, producing a perception of surrounding diffuse reverberation.

The reverberation produced by the different loudspeakers has to be mutually incoherent. In a simple case the reverberations can be produced using the different channels of the same reverberator, where the output channels are uncorrelated but otherwise share the same acoustic characteristics such as reverberation time and level (specifically, the diffuse-to-direct ratio or reverberant-to-direct ratio or diffuse-to-total ratio or diffuse-to-source ratio or any other suitable parameter for representing reverberation energy or level). Such uncorrelated outputs sharing the same acoustic characteristics can be obtained, for example, from the output taps of a feedback delay network (FDN) reverberator with suitable tuning of the delay line lengths and mixing matrix, or from a reverberator based on using decaying uncorrelated noise sequences by using a different uncorrelated noise sequence in each channel. In this case, the different reverberant signals effectively have the same features, and the reverberation is typically perceived to be similar in all directions.

An accurate perception of the source position and the acoustic features of the space are dependent on the temporal transition from the early reflections to the late reverberation and the level balance between these two phases or stages. When employing two separate rendering pipelines for the early reflections and one for the late reverberation, respectively, it is of particular importance to employ fine-grained control over the initial response of the late reverberation such that the region of transition between the early reflections 103 and late reverberation 107, which often overlap in time (such as shown by reference 105 of FIG. 1), may be accurately configured.

### SUMMARY

There is provided according to a first aspect an apparatus for applying reverberation to at least one audio signal, the apparatus comprising at least one processor and at least one memory storing instructions that, when executed by the at least one processor, cause the system at least to perform: obtaining the at least one audio signal; obtaining at least three reverberation parameters based on obtaining reverberation configuration information and directional configuration information; controlling a reverberator using the at least three reverberation parameters for providing a reverberant audio signal using the at least one audio signal, based on the at least three reverberation parameters, the reverberant audio signal comprising at least a late reverberation part; processing at least a portion of the reverberant audio signal, the portion of the reverberant audio signal at least partially interfering with a reflection audio signal; and generating a binaural output audio signal, the binaural output audio signal comprising the processed reverberant audio signal.

The apparatus may be further caused to perform determining the reflection audio signal from the at least one audio signal, wherein the reflection audio signal comprises at least an early reflections part.

The apparatus caused to perform determining the reflection audio signal from the at least one audio signal may be further caused to perform processing the at least one audio signal to generate the reflection audio signal.

The apparatus caused to perform generating the binaural output audio signal may be further caused to perform combining the processed reverberant audio signal and the reflection audio signal.

The apparatus may be further caused to perform providing a direct audio signal based on processing the at least one audio signal, wherein the binaural output audio further comprises the direct audio signal.

The apparatus caused to perform providing the direct audio signal based on processing the at least one audio signal may be further caused to perform applying to the at least one audio signal at least one of: distance gain attenuation; air absorption filtering, and directional reproduction processing.

The reverberant audio signal may further comprise at least one first echo, wherein the portion of the reverberant audio signal which at least partially interferes with the reflection audio signal is the at least one first echo.

The apparatus caused to perform processing at least a portion of the reverberant audio signal, the portion of the reverberant audio signal at least partially interfering with the reflection audio signal may be caused to perform one of: determining the portion of the reverberant audio signal at least partially interfering with a reflection audio signal based on an analysis of the reverberant audio signal and the reflection audio signal; or determining the portion of the reverberant audio signal based on a user input defining the at least partially interfering portion of the reverberant audio signal.

The reverberation configuration may comprise at least one of: at least one late reverberation time; at least one first echo arrival time; at least one first echo level.

The apparatus, caused to perform controlling the reverberator using the at least three reverberation parameters for providing the reverberant audio signal using the at least one audio signal may be caused to perform: controlling the reverberator comprising: a gain stage associated with late reverberation; a first stage delay line and a second stage delay line respectively for providing at least one first echo arrival time and for providing at least one parameter associated with the late reverberation, wherein the reverberator is configured to provide an output using the at least one audio signal based on the gain stage, the first stage delay line and the second stage delay line; providing at least one control line comprising at least one delay line and a gain filter, wherein the at least one delay line is associated with the first stage delay line and the gain filter is associated with the gain stage, and wherein the at least one delay line and the gain filter are configured based on the at least three reverberation parameters so as to cause an output from the at least one control line using the at least one audio signal.

The apparatus, caused to perform providing the reverberant audio signal using the at least one audio signal may be further caused to perform generating the at least one reverberated audio signal based on a combination of the at least one reverberator and the output of the at least one control line.

A timing and density of at least a first portion of the at least one reverberated audio signal output by the at least one reverberator may be defined by the at least three reverberation parameters.

The apparatus caused to perform obtaining at least three reverberation parameters may be further caused to perform obtaining: the first of the at least three reverberation parameters as at least one reverberation time for controlling the first stage delay line and the second stage delay line; the second of the at least three reverberation parameters as at least one first-echoes time-of-arrival for controlling the first stage delay line and the at least one control line delay line; and the third of the at least three reverberation parameters as at least one first-echoes level for controlling the at least one control line gain filter.

The reverberator may further comprise a feedback attenuation filter associated with the first stage delay line, wherein the at least one reverberation time is further for controlling the at least one feedback attenuation filter.

The reverberator may further comprise a feedback matrix.

The apparatus caused to perform controlling the reverberator based on the at least three reverberation parameters may be further caused to perform: applying the first stage delay line and the feedback attenuation filter preceding the feedback matrix to the at least one audio signal; applying the feedback matrix to an output of one of the first set of delay lines or the at least one feedback attenuation filter; and applying the second stage delay line succeeding the feedback matrix to an output of the feedback matrix, an output of the second stage delay line providing at least one input to the feedback network, wherein the reverberator is configured to generate at least two successive echoes.

The apparatus caused to perform processing at least a portion of the reverberant audio, the portion of the reverberant audio signal at least partially interferes with a reflection audio signal may be further caused to perform at least partially suppressing or otherwise modifying in amplitude a first echo of the at least one reverberant audio signal such that the at least one reverberant signal comprises reverberations which minimally interfere with or otherwise compliment the at least one reflection echoes.

The reverberation configuration may comprise at least one of: reverberation time; reverberant-to-direct ratio; diffuse-to-source energy ratio; pre-delay time; a first echo time-of-arrival specification; a first echo frequency contour specification; a virtual space geometry specification.

The directional configuration may comprise a spherical design such as a t-design, Lebedev grid, or other suitable uniform spherical layout with D points representing rendering directions.

According to a second aspect there is provided a method for applying reverberation to at least one audio signal, the method comprising: obtaining the at least one audio signal; obtaining at least three reverberation parameters based on obtaining reverberation configuration information and directional configuration information; controlling a reverberator using the at least three reverberation parameters for providing a reverberant audio signal using the at least one audio signal, based on the at least three reverberation parameters, the reverberant audio signal comprising at least a late reverberation part; processing at least a portion of the reverberant audio signal, the portion of the reverberant audio signal at least partially interfering with a reflection audio signal; and generating a binaural output audio signal, the binaural output audio signal comprising the processed reverberant audio signal.

The method may further comprise determining the reflection audio signal from the at least one audio signal, wherein the reflection audio signal comprises at least an early reflections part.

Determining the reflection audio signal from the at least one audio signal may be further comprise processing the at least one audio signal to generate the reflection audio signal.

Generating the binaural output audio signal may further comprise combining the processed reverberant audio signal and the reflection audio signal.

The method may further comprise providing a direct audio signal based on processing the at least one audio signal, wherein the binaural output audio further comprises the direct audio signal.

Providing the direct audio signal based on processing the at least one audio signal may further comprise applying to the at least one audio signal at least one of: distance gain attenuation; air absorption filtering, and directional reproduction processing.

The reverberant audio signal may further comprise at least one first echo, wherein the portion of the reverberant audio signal which at least partially interferes with the reflection audio signal is the at least one first echo.

Processing at least a portion of the reverberant audio signal, the portion of the reverberant audio signal at least partially interfering with the reflection audio signal may comprise performing one of: determining the portion of the reverberant audio signal at least partially interfering with a reflection audio signal based on an analysis of the reverberant audio signal and the reflection audio signal; or determining the portion of the reverberant audio signal based on a user input defining the at least partially interfering portion of the reverberant audio signal.

The reverberation configuration may comprise at least one of: at least one late reverberation time; at least one first echo arrival time; at least one first echo level.

Controlling the reverberator using the at least three reverberation parameters for providing the reverberant audio signal using the at least one audio signal may comprise: controlling the reverberator comprising: a gain stage associated with late reverberation; a first stage delay line and a second stage delay line respectively for providing at least one first echo arrival time and for providing at least one parameter associated with the late reverberation, wherein the reverberator is configured to provide an output using the at least one audio signal based on the gain stage, the first stage delay line and the second stage delay line; providing at least one control line comprising at least one delay line and a gain filter, wherein the at least one delay line is associated with the first stage delay line and the gain filter is associated with the gain stage, and wherein the at least one delay line and the gain filter are configured based on the at least three reverberation parameters so as to cause an output from the at least one control line using the at least one audio signal.

Providing the reverberant audio signal using the at least one audio signal may further comprise generating the at least one reverberated audio signal based on a combination of the at least one reverberator and the output of the at least one control line.

A timing and density of at least a first portion of the at least one reverberated audio signal output by the at least one reverberator may be defined by the at least three reverberation parameters.

Obtaining at least three reverberation parameters may further comprise obtaining: the first of the at least three reverberation parameters as at least one reverberation time for controlling the first stage delay line and the second stage delay line; the second of the at least three reverberation parameters as at least one first-echoes time-of-arrival for controlling the first stage delay line and the at least one control line delay line; and the third of the at least three reverberation parameters as at least one first-echoes level for controlling the at least one control line gain filter.

The reverberator may further comprise a feedback attenuation filter associated with the first stage delay line, wherein the at least one reverberation time is further for controlling the at least one feedback attenuation filter.

The reverberator may further comprise a feedback matrix.

Controlling the reverberator based on the at least three reverberation parameters may further comprise: applying the first stage delay line and the feedback attenuation filter preceding the feedback matrix to the at least one audio signal; applying the feedback matrix to an output of one of the first set of delay lines or the at least one feedback attenuation filter; and applying the second stage delay line succeeding the feedback matrix to an output of the feedback matrix, an output of the second stage delay line providing at least one input to the feedback network, wherein the reverberator is configured to generate at least two successive echoes.

Processing at least a portion of the reverberant audio, the portion of the reverberant audio signal at least partially interferes with a reflection audio signal may further comprise at least partially suppressing or otherwise modifying in amplitude a first echo of the at least one reverberant audio signal such that the at least one reverberant signal comprises reverberations which minimally interfere with or otherwise compliment the at least one reflection echoes.

The reverberation configuration may comprise at least one of: reverberation time; reverberant-to-direct ratio; diffuse-to-source energy ratio; pre-delay time; a first echo time-of-arrival specification; a first echo frequency contour specification; a virtual space geometry specification.

The directional configuration may comprise a spherical design such as a t-design, Lebedev grid, or other suitable uniform spherical layout with D points representing rendering directions.

According to a third aspect there is provided an apparatus for applying reverberation to at least one audio signal, the apparatus comprising means configured to: obtain the at least one audio signal; obtain at least three reverberation parameters based on obtaining reverberation configuration information and directional configuration information; control a reverberator using the at least three reverberation parameters for providing a reverberant audio signal using the at least one audio signal, based on the at least three reverberation parameters, the reverberant audio signal comprising at least a late reverberation part; processing at least a portion of the reverberant audio signal, the portion of the reverberant audio signal at least partially interfering with a reflection audio signal; and generate a binaural output audio signal, the binaural output audio signal comprising the processed reverberant audio signal.

The means may be further be configured to determine the reflection audio signal from the at least one audio signal, wherein the reflection audio signal comprises at least an early reflections part.

The means configured to determine the reflection audio signal from the at least one audio signal may further be configured to process the at least one audio signal to generate the reflection audio signal.

The means configured to generate the binaural output audio signal may be further configured to combine the processed reverberant audio signal and the reflection audio signal.

The means may be further configured to provide a direct audio signal based on processing the at least one audio signal, wherein the binaural output audio further comprises the direct audio signal.

The means configured to provide the direct audio signal based on processing the at least one audio signal may be configured to apply to the at least one audio signal at least one of: distance gain attenuation; air absorption filtering, and directional reproduction processing.

The reverberant audio signal may further comprise at least one first echo, wherein the portion of the reverberant audio signal which at least partially interferes with the reflection audio signal is the at least one first echo.

The means configured to process at least a portion of the reverberant audio signal, the portion of the reverberant audio signal at least partially interfering with the reflection audio signal may be configured to perform one of: determine the portion of the reverberant audio signal at least partially interfering with a reflection audio signal based on an analysis of the reverberant audio signal and the reflection audio signal; or determine the portion of the reverberant audio signal based on a user input defining the at least partially interfering portion of the reverberant audio signal.

The reverberation configuration may comprise at least one of: at least one late reverberation time; at least one first echo arrival time; at least one first echo level.

The means configured to perform controlling the reverberator using the at least three reverberation parameters for providing the reverberant audio signal using the at least one audio signal may be configured to: control the reverberator comprising: a gain stage associated with late reverberation; a first stage delay line and a second stage delay line respectively for providing at least one first echo arrival time and provide at least one parameter associated with the late reverberation, wherein the reverberator is configured to provide an output using the at least one audio signal based on the gain stage, the first stage delay line and the second stage delay line; provide at least one control line comprising at least one delay line and a gain filter, wherein the at least one delay line is associated with the first stage delay line and the gain filter is associated with the gain stage, and wherein the at least one delay line and the gain filter are configured based on the at least three reverberation parameters so as to cause an output from the at least one control line using the at least one audio signal.

The means configured to provide the reverberant audio signal using the at least one audio signal may be further configured to generate the at least one reverberated audio signal based on a combination of the at least one reverberator and the output of the at least one control line.

A timing and density of at least a first portion of the at least one reverberated audio signal output by the at least one reverberator may be defined by the at least three reverberation parameters.

The means configured to obtain the at least three reverberation parameters may be further configured to obtain: the first of the at least three reverberation parameters as at least one reverberation time for controlling the first stage delay line and the second stage delay line; the second of the at least three reverberation parameters as at least one first-echoes time-of-arrival for controlling the first stage delay line and the at least one control line delay line; and the third of the at least three reverberation parameters as at least one first-echoes level for controlling the at least one control line gain filter.

The reverberator may further comprise a feedback attenuation filter associated with the first stage delay line, wherein the at least one reverberation time is further for controlling the at least one feedback attenuation filter.

The reverberator may further comprise a feedback matrix.

The means configured to control the reverberator based on the at least three reverberation parameters may be further configured to: apply the first stage delay line and the feedback attenuation filter preceding the feedback matrix to the at least one audio signal; apply the feedback matrix to an output of one of the first set of delay lines or the at least one feedback attenuation filter; and apply the second stage delay line succeeding the feedback matrix to an output of the feedback matrix, an output of the second stage delay line providing at least one input to the feedback network, wherein the reverberator is configured to generate at least two successive echoes.

The means configured to process at least a portion of the reverberant audio, the portion of the reverberant audio signal at least partially interferes with a reflection audio signal may be further configured to at least partially suppress or otherwise modify in amplitude a first echo of the at least one reverberant audio signal such that the at least one reverberant signal comprises reverberations which minimally interfere with or otherwise compliment the at least one reflection echoes.

The reverberation configuration may comprise at least one of: reverberation time; reverberant-to-direct ratio; diffuse-to-source energy ratio; pre-delay time; a first echo time-of-arrival specification; a first echo frequency contour specification; a virtual space geometry specification.

The directional configuration may comprise a spherical design such as a t-design, Lebedev grid, or other suitable uniform spherical layout with D points representing rendering directions.

According to a fourth aspect there is provided an apparatus for applying reverberation to at least one audio signal, the apparatus comprising: obtaining circuitry configured to obtain the at least one audio signal; obtaining circuitry configured to obtain at least three reverberation parameters based on obtaining reverberation configuration information and directional configuration information; controlling circuitry configured to control a reverberator using the at least three reverberation parameters for providing a reverberant audio signal using the at least one audio signal, based on the at least three reverberation parameters, the reverberant audio signal comprising at least a late reverberation part; processing circuitry configured to process at least a portion of the reverberant audio signal, the portion of the reverberant audio signal at least partially interfering with a reflection audio signal; and generating circuitry configured to generate a binaural output audio signal, the binaural output audio signal comprising the processed reverberant audio signal.

According to a fifth aspect there is provided a computer program comprising instructions [or a computer readable medium comprising instructions] for causing an apparatus, for applying reverberation to at least one audio signal, the apparatus caused to perform at least the following: obtaining the at least one audio signal; obtaining at least three reverberation parameters based on obtaining reverberation configuration information and directional configuration information; controlling a reverberator using the at least three reverberation parameters for providing a reverberant audio signal using the at least one audio signal, based on the at least three reverberation parameters, the reverberant audio signal comprising at least a late reverberation part; processing at least a portion of the reverberant audio signal, the portion of the reverberant audio signal at least partially interfering with a reflection audio signal; and generating a binaural output audio signal, the binaural output audio signal comprising the processed reverberant audio signal.

According to a sixth aspect there is provided a non-transitory computer readable medium comprising program instructions for causing an apparatus, for applying reverberation to at least one audio signal, to perform at least the following: obtaining the at least one audio signal; obtaining at least three reverberation parameters based on obtaining reverberation configuration information and directional configuration information; controlling a reverberator using the at least three reverberation parameters for providing a reverberant audio signal using the at least one audio signal, based on the at least three reverberation parameters, the reverberant audio signal comprising at least a late reverberation part; processing at least a portion of the reverberant audio signal, the portion of the reverberant audio signal at least partially interfering with a reflection audio signal; and generating a binaural output audio signal, the binaural output audio signal comprising the processed reverberant audio signal.

According to a seventh aspect there is provided an apparatus, for applying reverberation to at least one audio signal, comprising: means for obtaining the at least one audio signal; means for obtaining at least three reverberation parameters based on obtaining reverberation configuration information and directional configuration information; means for controlling a reverberator using the at least three reverberation parameters for providing a reverberant audio signal using the at least one audio signal, based on the at least three reverberation parameters, the reverberant audio signal comprising at least a late reverberation part; means for processing at least a portion of the reverberant audio signal, the portion of the reverberant audio signal at least partially interfering with a reflection audio signal; and means for generating a binaural output audio signal, the binaural output audio signal comprising the processed reverberant audio signal.

According to an eighth aspect there is provided a computer readable medium comprising instructions for causing an apparatus, for applying reverberation to at least one audio signal, to perform at least the following: obtaining the at least one audio signal; obtaining at least three reverberation parameters based on obtaining reverberation configuration information and directional configuration information; controlling a reverberator using the at least three reverberation parameters for providing a reverberant audio signal using the at least one audio signal, based on the at least three reverberation parameters, the reverberant audio signal comprising at least a late reverberation part; processing at least a portion of the reverberant audio signal, the portion of the reverberant audio signal at least partially interfering with a reflection audio signal; and generating a binaural output audio signal, the binaural output audio signal comprising the processed reverberant audio signal.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows a model of room acoustics with regard to the room impulse response;

FIG. 2 shows schematically a reverberator which includes an example feedback delay network (FDN) according to some embodiments;

FIG. 3 shows schematically an example apparatus within which the reverberator which includes an example feedback delay network (FDN) as shown in FIG. 2 according to some embodiments;

FIG. 4 shows schematically an example reverberator parameter determiner as shown in FIG. 3 in further detail according to some embodiments;

FIG. 5 shows an example source distribution and echoes associated with the sources;

FIG. 6 shows a flow diagram of the operation of the example apparatus as shown in FIG. 3 with respect to reverberant audio signal rendering;

FIG. 7 shows schematically an example binaural renderer as shown in FIG. 3 in further detail according to some embodiments;

FIG. 8 shows an example renderer incorporating the reverberator as shown in FIG. 3;

FIG. 9 shows schematically an example early reflection processor and renderer as shown in FIG. 3 according to some embodiments;

FIG. 10 shows an example showing early reflections processing;

FIG. 11 shows an example system within which some embodiments can be implemented; and

FIG. 12 shows an example device suitable for implementing the apparatus shown in previous figures.

### EMBODIMENTS OF THE APPLICATION

The following describes in further detail suitable apparatus and possible mechanisms for determining configurable initial characteristics for diffuse late reverberation rendering for physical or virtual audio scenes.

In a virtual acoustics rendering system, reverberation is typically rendered as a combination of a certain number of distinct early reflections (or reflection echoes) and a stochastic model for the late reverberation. The early reflection synthesis is thus typically position-dependent in that it varies with source and listener positions, while the late reverberation synthesis is not. Together these two can create a plausible reverberation rendering for a physical or virtual space. The reverberation rendering is combined (summed) with direct sound rendering, which involves distance gain attenuation, air absorption filtering, and directional reproduction (binaural or loudspeaker) of the direct sound component that directly propagates to the ears of the listener without reflecting or reverberating in the space.

To produce a good quality reverberation output the late reverberation is configured such that the transition from the early reflections to the late reverberation is perceived as smooth and continuous, without noticeable gaps or energy fluctuation. The rendering is implemented by constructing the impulse responses offline (or as a background process) then the part of the impulse response corresponding to the late part can be processed to ensure it fits well with the early reflections.

However, when rendering is performed without offline creation of impulse responses using, for example, digital reverberators then such offline processing of the impulse responses is not possible since impulse responses may not be available in the system. An example of such a system uses a geometric model to produce early reflections and a feedback delay network (FDN) digital reverberator to produce the late reverberation.

It has been suggested that a second FDN with a shorter reverberation time is used to filter the input signal generating a second reverberant signal which can then be inverted in phase relative to the primary FDN and added to the output signal of the primary FDN to achieve suppression (or control) of the early echoes (or pulses if referring to an impulse response) produced by the primary FDN and to reduce their interference with separately-rendered early reflections. However, this can be computationally complex as it requires running two complete FDNs in parallel (and therefore requires double the number of calculations compared to a single FDN). Moreover, such suggested methods can be difficult to configure as they require two complete sets of reverberator parameters to be used for configuration.

The concept as discussed with respect to the examples and embodiments hereafter in further detail is one of apparatus and methods which aim to control the early behavior of an FDN with low computational complexity, fine-grained early echo control independent of the aggregate system decay properties, and which achieve an improved control of the transition behavior between the FDN output and synthesized early reflections.

Employing such embodiments enables the apparatus and methods to implement a modification of the first echoes (or in other words can be considered to implement transition control of the hybrid early-reflection-plus-stochastic-late reverberator). Notably, these embodiments implement independent control over three aspects of reverberation synthesis, which are:
1) shortened (and modifiable) onset time to a spatially and temporally diffuse response;
2) precise temporal placement of the reverberator's first echoes, separate from the aggregate loop delay line lengths (which determine the modal density of the system and are controlled separately); and
3) control of the spectral contour of the first echoes, independent of the delay-proportional absorption attenuation filtering.

The embodiments thus implement a granular control over the early-to-late transition response in a reverberator. Furthermore, as discussed in further detail with respect to the following embodiments, the first echoes of the FDN can be controlled or configured to compliment or otherwise augment the early reflection rendering through its precise temporal and spectral adjustment.

The aim of these embodiments is to implement a rendering of reverberation in which parametric control over both early and late stages of the reverberator's response by using a dual-delay-stage architecture is employed. In such embodiments therefore there is the aim of enabling the detailed temporal alignment and level modification of the first echoes independent of late-stage design constraints.

The benefits of the proposed embodiments therefore aim to include the following:
1. A precise temporal placement of the reverberator's first echoes to align with a geometric approximation of second order, third order, etc. (reflection) echoes;
2. A faster diffuse onset time, in both the omnidirectional and directional response;
3. A defined or specified first echo arrival time independent of the overall system channel loop delay times;
4. A control of the (frequency-dependent) level of the first echoes, not only suppression, but also amplification, and specification of the phase sign of the first echoes. Thereby, the spectral response of a particular order of early reflection can be targeted in order to augment the separately-rendered early reflections. This requires no additional resources as it is achieved with control line EQ filters that might otherwise have been parameterized for first-echo suppression;
5. A more resource efficient implementation (for example system memory) because the first-stage delay line length (which are duplicated in the control lines) can be shorter than the overall channel loop delay lengths. This is enabled by the second-stage delay lines (which are not replicated in the control lines) which account for the “full” system channel loop delay times;
6. A more resource efficient implementation (for example system memory) because the implementation of a shorter diffuse onset, which in turn means that for a target diffuse onset an additional delay is not required for all system loop channels and control line channels, but rather to the single-channel pre-delay delay line;
7. A more resource efficient implementation (for example computation resources) for implementing temporal alignment and early dispersion control when a first echo amplitude modification is bypassed, in which case no control lines (EQ or delay lines) are necessary, making the resource usage equivalent to a standard FDN.

The embodiments relate to reproduction of the middle and late stages of reverberation within a rendering of an audio signal, wherein apparatus and methods are proposed that permit the configuration of characteristics of an early-to-middle stage of a digital reverberator. These characteristics can be one or more of: an initial echo density; a diffuse onset timing; and a frequency-dependent level of first echoes. Additionally these apparatus and methods permit the configuration of characteristics of late-stage reverberation. Both of these can be implemented by independent control of the overall decay characteristics.

Furthermore these embodiments enable a rendering where the rendered middle stage of the reverberation has a desired interaction with separately rendered reflection echoes. Designing this interaction can in some embodiments involve augmenting the reflection echoes by modifying first echoes to match the temporal echo density and/or to match the frequency-dependent levels to that of a target order of reflection echo, or minimizing interference with reflections echoes by modifying the temporal alignment of first echoes so as not to coincide or nearly coincide with reflection echoes or by at least partially suppressing or fully silencing first echoes.

The embodiments described in further detail herein show apparatus and methods configured to:
1) obtain a reverberation configuration specification comprising
   a) at least one late reverberation time (broadband or frequency-dependent),
   b) at least one first echo arrival time,
   c) at least one first echo level (broadband or frequency-dependent);
2) configure a feedback network (FN), using the reverberation configuration specification, which involves
   a) configuring at least one delay line belonging to a first stage of a two-stage (or also called a “dual-stage”) delay line architecture wherein the first stage is configured to achieve the desired first echo arrival time (such as defined above in 1b),
   b) configuring a second stage of the two-stage delay architecture wherein the second stage is configured to achieve, by its interaction with the first delay stage, the desired diffuse onset rate or other design criteria related to late reverberation such as modal density or the correspondence of echo density to geometry of a virtual acoustic space,
   c) configuring a frequency-dependent gain stage within the loopback path of the FN such that the desired late-stage reverberation time is achieved, and
   d) configuring a mixing matrix in the FN loopback path;
3) configure at least one first echo control line using the reverberation configuration specification, which involves
   a) configuring at least one delay line to achieve a corresponding first-stage delay,
   b) configuring a gain stage (broadband or frequency-dependent);
4) produce an output from the at least one control delay line using at least one input signal;
5) render a reverberated signal by using the FN applied to an at least one input signal; and
6) combine the output of the at least one first echo control line with the corresponding output channel of the FN, thereby achieving the specified first echo level (which may be frequency dependent).

It is noted that in some embodiments the configuration specification can be generated by higher-level descriptors such as diffuse onset time and/or target-order reflection characteristics.

In the following examples the term control line is used. However this can also be referred as a modification line or any suitable term for at least one delay line (and in some embodiments at least one associated frequency dependent gain element or more generally frequency dependent filter element) configured to control or modify the ‘first’ echo output.

The following examples thus describe in further detail suitable apparatus and possible mechanisms for controlling the middle and late stages of artificial reverberation, in combination with separate mechanisms for reflection echo rendering and decoding spatial audio output to a target rendering format, for the purpose of presenting audio scenes with diffuse reverberation.

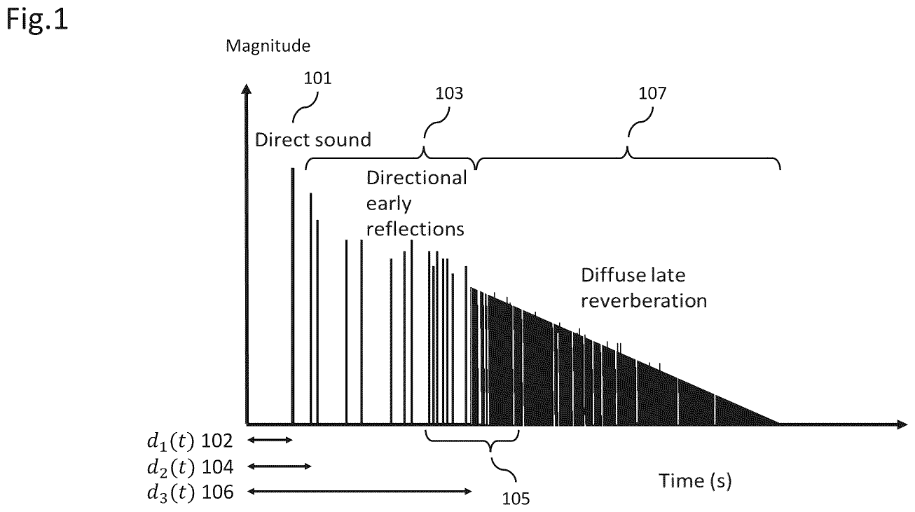

In a virtual acoustics rendering system, reverberation is typically rendered, as described above and shown with respect to the example in FIG. 1, as a combination of at least two echo-generating components. A first component is a so-called early reflection echo synthesis component which generates a certain number of perceptually distinct echoes. A second component is a late reverberation synthesis component which generates a stream of echoes which are relatively indistinct but adhere to the overall decay properties of a stochastic model for the late reverberation.

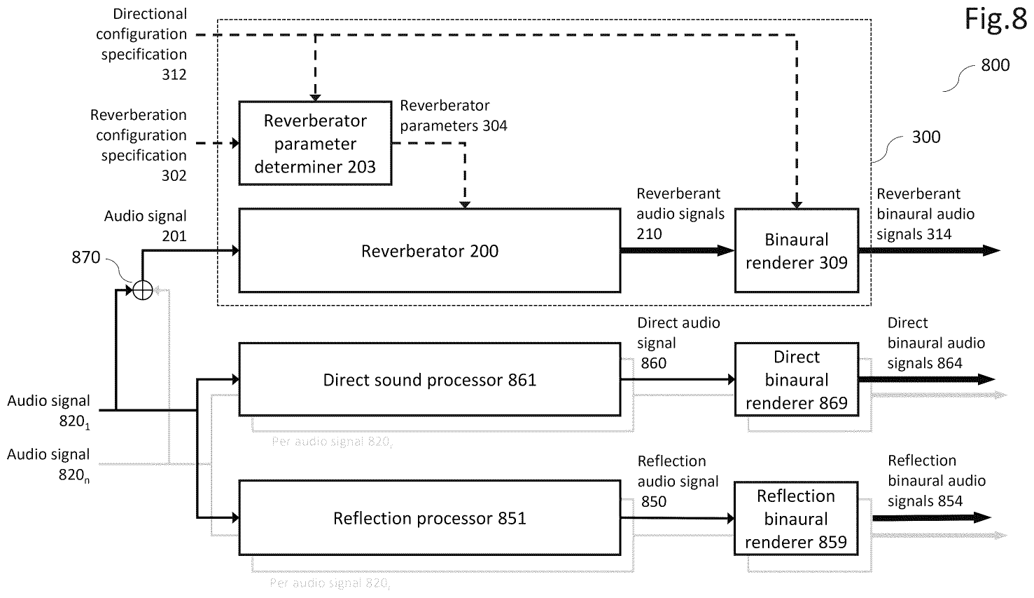

Herein these “early reflection echoes” are simply “reflection echoes” to disambiguate echoes produced by a reflection processor (which is shown later in the render system of FIG. 8 with reference 851) from other echoes generated by the reverberation system which lie in the early-to-middle part of the overall system response (such as shown by reference 105 of FIG. 1). The echoes resulting from multiple successive passes through the FN are referred to as early echoes, or middle-stage echoes, up to a transition time (such as shown by the time period in FIG. 1 with the reference 106) after which further cycles through the FN produce perceptually indistinguishable echoes called late echoes, diffuse tail, late reverberation, or similar (as shown by the reference 107 of FIG. 1).

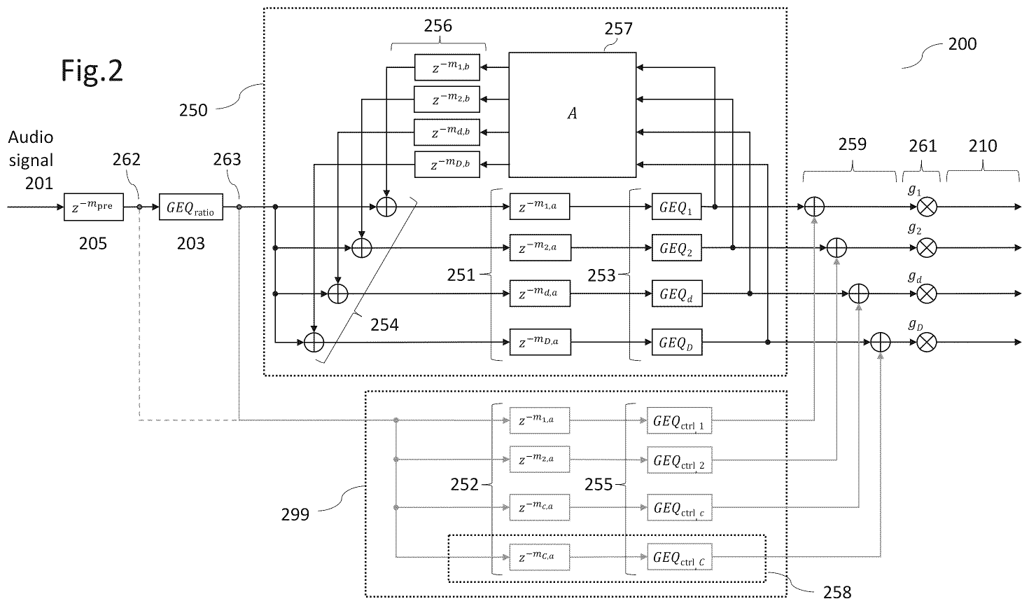

With respect to the following examples and embodiments the early echoes modified are those generated from the FN (as shown in FIG. 2 by reference 250), after a first pass through the first stage delay lines and feedback attenuation filters (by reference 251 and 253, respectively), prior to recirculating, and are specifically referred to as first echoes. So-called reflection echoes are generated by a reflection processor which is external to, and runs in parallel with, the reverberator.

Reflection echo synthesis is typically spatially dynamic in that the levels and directions of arrival (DoAs) of the reflections depend on the source and listener positions and orientations. The reflection processor is configured to produce a discrete number of echoes that are precise and independently varied in their intensity and coloration, as determined by attenuation with distance, air absorption filtering, reflection surface absorption filtering, and which are specular relative to features and geometry of the modelled room which in turn determines their encoded DoA. These echoes correspond to early reflections depicted in the impulse response (as shown in FIG. 1 by the reference 103). The reflection processor is external to and running in parallel with the reverberator. Herein, the echoes produced by the reflection processor are referred to as reflection echoes.

Late reverberation, in contrast to the early reflections described above, is not considered to be spatially dynamic in that the echoes produced in late reverberation synthesis do not vary with source-listener position. The reverberator is therefore configured to produce, by way of a feedback network, a decaying stream of many echoes which increase in number (density) while decreasing in intensity (loudness) over time, as characterized by the decay properties of stochastic late reverberation (as shown in FIG. 1 by the reference 107). This can be achieved by the feedback (FB) architecture of the reverberator, in which an input audio signal passes through the network, splitting into numerous paths which form “echoes” which are separated in time by independent delay lines, all of which subsequently recirculate through the network, being further divided among the delay lines, subsequently splitting into more echoes with each recirculation through the network, and so on. These echoes can be made to have only a loose correspondence to the geometry of the virtual room so do not represent geometrically precise (specular) reflections, nor do they convey the attenuation characteristics of specific reflection surfaces.

It is noted that there is computational overhead associated with the changing characteristics of reflection echoes, which are updated as the relative source-listener position and orientation changes. This complexity is further compounded in systems with more than one sound source (where there are separate source audio signals input to the system and corresponding multiplicity of direct sound processors and reflection processors). This can be contrasted with late reverberation synthesis where complexity does not increase correspondingly with more source signals, as the late reverberation synthesis accepts as an input a single audio signal which is a combination or summation of input source signals. Furthermore, the parameters associated with late reverberation synthesis are not updated with varying source-receiver positions.

As indicated by the following embodiments the rendering of reverberation can be implemented for a virtual acoustic space where the transition from the early reflections to the late reverberation is perceived without noticeable gaps or energy fluctuation. This is in part because the feedback network (FN) may produce perceptually distinct early echoes which may be confused for early reflections, from a perceptual standpoint.

These early echoes from the FN do not have the geometry-derived dynamics or adherence to source-listener orientation, as the early reflections are meant to, and therefore interfere with reflection echoes and detract from the overall plausibility of the virtual acoustic scene rendering. The embodiments described herein aim to overcome this challenge by enabling the configuration of a FN to modify both the precise temporal placement and frequency-dependent amplitude of individual echoes from the early stage of the reverberator (corresponding to a “middle” stage of the overall reverberation system response) so as to enhance or otherwise compliment the separately-synthesized reflection echoes.

Additionally, these embodiments aim to modify the timing of the diffuse onset of the reverberator independent of overall decay properties. This can be implemented in some embodiments by the dual-stage delay architecture of the proposed design such as shown in FIG. 2, which enables the separate parameterization of first-echo timing and aggregate delay length density.

FIG. 2 shows an example reverberator 200 which could be employed in some embodiments. The reverberator 200 is configured to receive the audio signal 201 (which can be designated Sin (t), where t is the sample (time) index). Furthermore, the reverberator 200 is configured based on (received) reverberator parameters and the first echo modifier parameters. In some embodiments the reverberator 200 is further configured to receive directional configuration (and the room dimensions) that may be used to configure the reverberation.

The reverberator 200 is shown herein employing a feedback network (FN) 250 implemented as a feedback delay network (FDN) with a dual-delay architecture but in other embodiments the FN can be implemented using other suitable feedback architectures. The dual-delay architecture comprises a first delay stage (or first-stage delays) which is configured to achieve the desired first echo arrival time and a second delay stage (or second-stage delays) configured to achieve, by its interaction with the first delay stage, the desired diffuse onset rate or other design criteria related to late reverberation such as modal density or the correspondence of echo density to geometry of a virtual acoustic space.

In this example embodiment, the reverberator 200 has D (for example D=15) output channels indexed with d=1, 2, . . . , d, . . . , D. The resulting reverberant audio signals 210 sᵣₑᵥ(t, d) are mutually incoherent, and they have acoustical characteristics according to the reverberator parameters and the first echoes are modified (for example attenuated, cancelled, or otherwise changed) in amplitude or temporal alignment. This modification can be based on first echo modifier parameters.

The D uncorrelated outputs are subsequently rendered from different spatial directions defined by the directional configuration.

In some embodiments the reverberator 200 comprises a pre-delay line z^{-m}^{ₚᵣₑ} 205, configured to receive and delay the input audio signal. The reverberator 200 also comprises a reverberation ratio control filter GEQᵣₐₜᵢₒ 203 which is configured to receive the pre-delay line output 262. The reverberator 200 further comprises a number D of first-stage feedback delay lines z^{-m}^{_{d,a}} 251 (denoted with an “a” subscript) and corresponding first-stage feedback delay line attenuation filters GEQ_{d} 253. The signals which are output from the first-stage feedback delay line attenuation filters GEQ_{d} 253 are sent to inputs of a feedback matrix A 257. The outputs of the feedback matrix A 257 are sent to D second-stage feedback delay lines z^{-m}^{_{d,b}} 256 (denoted with an “b” subscript). D signal combiners 254 (adders) sum the outputs of the second-stage feedback delay lines z^{-m}^{_{d,b}} 256 with the output of GEQᵣₐₜᵢₒ 203 to be used as inputs to each of the feedback delay lines z^{-m}^{_{d,a}} 251.

The output of the feedback network 250 can then be passed to signal combiners 259.

The reverberator 200 furthermore comprises a first echo modifier 299. The first echo modifier 299 comprises C control (or modification) lines 258. Each of the control (or modification) lines can comprise a control or modification delay line z^{-m}^{_{c,a}} 252 in series with a frequency dependent gain element or control line attenuation filter GEQ_{ctrl,c} 255, depicted in grey in FIG. 2. The echoes produced by the control lines 258 of the first echo modifier 299 are designated as control or modification echoes, each of which suppress or otherwise modify the amplitude or spectral contour of a first echo from the FN 250. The first echoes are the signals which have passed through the first-stage feedback delay lines 251 and feedback delay line attenuation filters 253 only once and have not yet recirculated through the feedback matrix A 257 or second-stage delay lines 256.

The control delay line 252 lengths m_{c,a}, where c=1, 2, . . . . C and c designates the associated first-stage delay line, have the same lengths as those of the feedback delay lines 251 in the FN 250 whose corresponding output channels carry the first echoes to be modified.

The control line attenuation filters GEQ_{ctrl,c} 255 are designed and configured such that, when their output signals are combined with the output signals from the feedback delay line attenuation filters GEQ_{d} 253, the first echoes from the FN are modified to a desired spectral contour and level. Due to the configuration of the control delay lines z^{-m}^{_{c,a}} 252 and control line attenuation filters GEQ_{ctrl,c} 255, the control echoes from the first echo suppressor are coincident in time with the corresponding first echoes of the FN to be modified. The output signals from the control lines are routed to signal combiners 259 which are configured to combine them with corresponding outputs from FN.

The reverberator further comprises C signal combiners 259 which combine the outputs of feedback delay line attenuation filters GEQ_{d} 253 with the outputs of the first echo modifier 299 control line attenuation filters GEQ_{ctrl,c} 255. The outputs of the signal combiners 259 (or, in the case that C<D, outputs of delay line attenuation filters GEQ_{d} 253 which are not routed to a signal combiner 259) are routed to D signal multipliers 261 which in turn output the reverberant audio signals 210.

In the example shown in FIG. 2, the number C of control delay lines 252 in the first echo modifier 299 is the same as the number D of recirculating delay lines in the FN 250. However, in some embodiments C need not equal D and in some embodiments C<D. For example, the first three control delay lines c=1, 2, 3, could be used to suppress or otherwise modify first echoes associated with the FN delay lines identified by the indices d=1, 4, 6.

The control delay lines 252 are noncirculating delay lines (thus are not sent through the feedback loops) whereas feedback delay lines 251 and 256 recirculate through the feedback loops. The outputs from the feedback delay lines 251 go through the feedback matrix A 257 and subsequently, after the resultant mixing and routing operation of feedback matrix A 257, through the second-stage feedback delay lines 256 which then are part of the input of the feedback delay lines 251.

In some embodiments the reverberator 200 is configured to receive reverberator parameters which comprise a delay length mₚᵣₑ, in samples, for pre-delay line z^{-m}^{ₚᵣₑ} 205, coefficients of a reverberation ratio control filter GEQᵣₐₜᵢₒ 203, delay lengths m_{d,a} for each of D first-stage feedback delay lines z^{-m}^{_{d,a}} 251, coefficients for each of D feedback delay line attenuation filters GEQ_{d} 253, coefficients for the feedback matrix A 257, and delay lengths mab for each of D second-stage feedback delay lines z^{-m}^{_{d,b}} 256. The reverberator parameters also comprise output channel gains g_{d} which are used to configure D signal multipliers 261.

In some embodiments the frequency dependent gain elements or attenuation filters GEQ_{d} 253 and GEQ_{ctrl,c} 255 are implemented as graphic equalizer (EQ) filters using M biquad IIR band filters. In the case of octave-band filtering, M=10. Thus, the reverberator parameters corresponding to each graphic EQ filter comprise the feedforward and feedback coefficients for 10 biquad IIR filters, the gains for biquad band filters, and the overall gain.

The feedback delay lines z^{-m}^{_{d,a}} 251 and z^{-m}^{_{d,b}} 256 can also be referred as first-stage and second-stage, respectively, loop delay lines or recirculating delay lines and the feedback delay line attenuation filters GEQ_{d} 253 can be referred to as loop filters or recirculating filters. In some embodiments the coefficients of feedback matrix A 257 are hardcoded in software code rather than provided as parameters.

The reverberator thus comprises multiple recirculating delay lines associated with the feedback network (FN) 250. The feedback matrix A 257 is used to control the recirculation gain and routing within the network. The feedback delay line attenuation filters GEQ_{d} 253 can be implemented in some embodiments as graphic EQ filters implemented as cascades of second-order section IIR filters and can facilitate controlling the energy decay rate at different frequencies. The feedback delay line attenuation filters GEQ_{d} 253 furthermore are designed such that they attenuate the signal by the desired amount with each pass through the FN such that the desired reverberation time (RT₆₀) is achieved.

The number of delay lines D (and the control delay lines C) can be adjusted depending on quality requirements and the desired tradeoff between reverberation quality (e.g. modal density, temporal and spatial diffuseness, diffuse onset time) and computational complexity. In an embodiment, an efficient implementation with D=15 delay lines is used. This makes it possible to define the coefficients of the feedback matrix A 457 as proposed by Rocchesso in Maximally Diffusive Yet Efficient Feedback Delay Networks for Artificial Reverberation, IEEE Signal Processing Letters, Vol. 4. No. 9, September 1997, in terms of a Galois sequence facilitating efficient implementation.

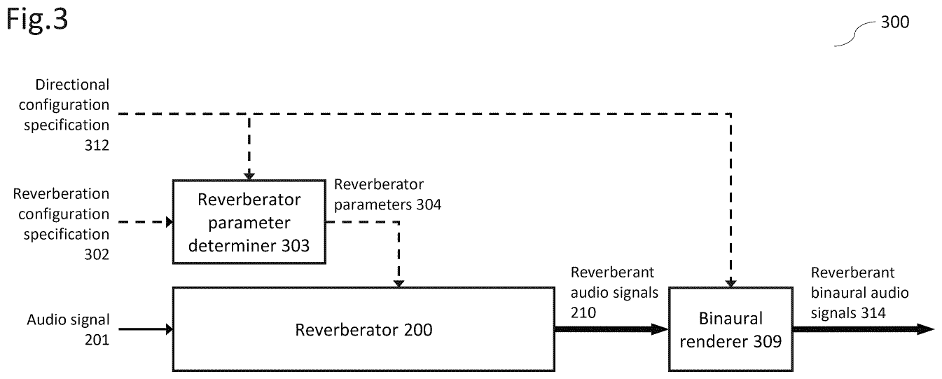

FIG. 3 shows an example system or apparatus representing a reverberator processing system 300 suitable for the rendering middle- and late-stage reverberation elements or parts according to some embodiments and which employs the reverberator 200 as shown in FIG. 2.

The system comprises inputs such as audio signal 201, reverberation configuration specification 302, and directional configuration specification 312. Reverberator processing system 300 further comprises a binaural renderer 309 configured to render reverberant binaural signals 314 with late reverberation that is perceived according to the reverberant characteristics specified in the reverberation configuration specification 302 and directional characteristics specified in the directional configuration specification 312. The reverberation configuration specification 302 and directional configuration specification 312 can, for example, be obtained from a bitstream or from a listening space description format (LSDF) input to the renderer.

In some embodiments, the reverberation configuration specification 302 comprises suitable parameters for configuring the reverberator 200. Suitable reverberation configuration specification 302 includes, for example, the reverberation times RT₆₀(k) in frequency bands (where k is the frequency band index), reverberant-to-direct ratio RDR(k), pre-delay time tₚᵣₑ, a first echo time-of-arrival specification, a first echo frequency contour specification, and/or a virtual space geometry specification. Alternative to the RDR, the diffuse-to-source energy ratio (DSR) can be used.

In some embodiments, the directional configuration specification 312 can indicate directions that can be used to render the reverberation by a suitable rendering scheme that creates a perception of enveloping diffuse reverberation, such as ambisonics or amplitude panning rendering, or simply rendered directly to a surrounding (real or virtual) loudspeaker setup. As an example, the directional configuration may specify a spherical design such as a t-design, Lebedev grid, or other suitable (nearly) uniform spherical layout with D points representing rendering directions (and thus the number of reverberator output channels).

In some embodiments, the reverberator processing system 300 comprises a reverberator parameter determiner 303 configured to obtain the reverberation configuration specification 302 and directional configuration specification 312. The reverberator parameter determiner 303 is configured to convert these specifications into suitable reverberator parameters 304 for the reverberator 200.

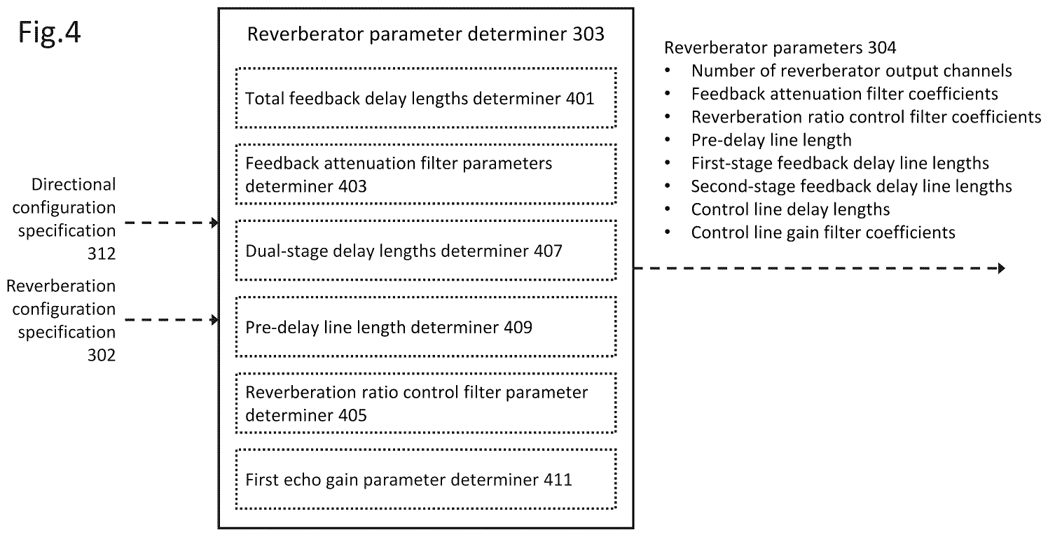

FIG. 4 shows a schematic view of an example reverberator parameter determiner 303 as shown in FIG. 3 according to some embodiments. The reverberator parameter determiner 303 is configured to obtain as inputs the directional configuration specification 312 and reverberation configuration specification 302 and based at least in part of these inputs generate suitable reverberator parameters 304, such as:
number of reverberator output channels;
first-stage feedback delay line lengths;
second-stage feedback delay line lengths;
control line delay lengths (matching first-stage delay lengths);
feedback attenuation filter coefficients;
reverberation ratio control filter coefficients;
pre-delay line length; and
control line gain filter coefficients.

For example, in some embodiments, the reverberator parameter determiner 303 comprises a total feedback delay line lengths determiner 401 which is configured to determine the so-called total feedback delay lengths m_{d} for each of the D channels of the reverberator, and which comprise a pair of first- and second-stage delay lines, respectively m_{d,a} and m_{d,b}, i.e. m_{d}=m_{d,a}+m_{d,b}. Note that ma is not necessarily output as a reverberator parameter but can be employed by further components of the reverberator parameter determiner 303.

The total feedback delay lengths m_{d} can be based on a virtual space geometry specification. For example, a bounding box that encloses or is aligned with the walls of the physical or virtual room can be defined with dimensions xDim, yDim, zDim. If the room is not shaped as a shoebox (or cuboid) then a shoebox can be fit inside or around the room and the dimensions of the fitted shoebox can be utilized for the delay line lengths. Alternatively, the dimensions can be obtained as three longest orthogonal dimensions in the non-shoebox shaped room, or by a mesh if the bounding box is provided as a mesh, or by another suitable method. When the method is executed in a renderer then the enclosure vertices are obtained from the bitstream (for VR acoustic environments) or the LSDF (for an AR acoustic environment) and the dimensions can be calculated.

The total feedback delay lengths m_{d} can, in some embodiments, be set proportionally to standing wave resonance frequencies in the virtual room or physical room (the acoustic environment).

The dimensions can further be converted to modified dimensions of a virtual room or enclosure by predetermined ratios which are suited for the generation of preferable room modes.

The delay line lengths sum m_{d} can further be made to be mutually prime integers. This choice minimizes coherent repetition in the impulse response of the FN. The sieve of the Sundaram algorithm can be used to find the prime numbers up to the maximum delay line length. Each delay line length can then be mapped to the closest prime number in the obtained set of prime numbers.

In some embodiments the reverberator parameter determiner 303 further comprises a feedback attenuation filter parameter determiner 403 which is configured to determine attenuation filter coefficients for feedback attenuation filters GEQ_{d} 253. The filter coefficients can be configured so that the rate of attenuation produced by the recirculation through the dual-stage delay lines results in the desired reverberation time RT₆₀(k). This determination can be implemented in a frequency-dependent manner to ensure the appropriate rate of decay of signal energy at specified frequencies. For a frequency bin k, the desired attenuation per signal sample is γₛₐₘₚ(k)=−60/(fₛ*RT₆₀(k)) dB, where fₛ is the sampling rate. The attenuation in decibels for a delay line pair of aggregate length m_{d}, where m_{d}=m_{d,a}+m_{d,b}, is then

$${γ}_{{GEQ}_{d}} ( k ) = {m}_{d} * {γ}_{samp} ( k ) ,$$

which serves as a target command gain in the design procedure of cascade graphic equalizer filters as described in V. Välimäki and J. Liski, “Accurate cascade graphic equalizer,” IEEE Signal Process. Lett., vol. 24, no. 2, pp. 176-180, February 2017, to produce the attenuation filter coefficients for GEQ_{d}. The cited design procedure operates in octave bands, although methods for similar graphic EQ structures can support third octave bands, increasing the number of biquad filters to 31 and providing a better match for detailed target responses, such as detailed in J. Rämö, J. Liski, and V. Välimäki, “Third-Octave and Bark Graphic-Equalizer Design with Symmetric Band Filters,” Applied Sciences, vol. 10, no. 4, p. 1222 February 2020.

In some embodiments the reverberator parameter determiner 303 further comprises a dual stage delay lengths determiner 407 which may set the length of the delays in each delay line pair, m_{d,a} and m_{d,b}, based on the first echoes time-of-arrival (ToA) specification of the reverberation configuration specification 302. The first echoes ToA specification may be set as either a specific delay time in a unit of time or samples, for which will be resolved into a sample delay m_{d,a} and for which m_{d,a}≤m_{d}. Alternatively, the first echoes time-of-arrival specification in reverberation configuration specification 302 can indicate a ratio of the lengths m_{d,a}:m_{d,b}, to be resolved from the length m_{d}. or may alternatively indicate the first- or second-stage delay lengths as a fraction of length m_{d}, by which both m_{d,a} and m_{d,b} are resolved by the relationship m_{d}=m_{d,a}+m_{d,b}.

These methods of resolving m_{d,a} and m_{d,b} can compensate for the value of tₚᵣₑ (whether specified directly in reverberation configuration specification 302 or produced by pre-delay line length determiner 409). The first echoes ToA specifications can be set for each of the D channels independently, or as a single common value to be resolved by the dual stage delay lengths determiner 407 into individual values based on the total feedback delay lengths m_{d}.

As indicated above the total feedback delay line lengths determiner 401 may set the delay line lengths sum m_{d} to be made to be mutually prime integers, and the dual stage delay lengths determiner 407 may further set the first and second stage delay lengths, m_{d,a} and m_{d,b}, to be mutually prime integers.

In some embodiments the dual stage delay lengths determiner 407 resolves the lengths m_{d,a} and m_{d,b}, in samples, to maintain the relationship m_{d}=m_{d,a}+m_{d,b}. Furthermore it is noted that the resultant first echoes are output at a time delay equal to mₚᵣₑ+m_{d,a}.

The example dual-stage delay architecture enables creating first echoes from the FN earlier than a conventional structure with only a single stage of delay lines equal to m_{d}. since m_{d,a}<m_{d}.

Furthermore the embodiments enable the control of onset timing of the diffuse reverberation by employing the dual-stage delay architecture.

As stated previously, the role of the reverberator, when used in conjunction with a reflection processor, is to reproduce so-called late reverberation which has a character of dense echoes that are both temporally and spatially diffuse. As such, it is desirable for the reverberator to produce a diffuse response as quickly as possible after the first echoes to satisfy its defined role in the overall reverberation system. In other words, the reverberator response should be perceptually diffuse after the fewest possible circulations through the feedback network.

A single-stage delay architecture FDN can produce an early response which is still perceptually sparse, for example, after one to five passes through the feedback network. With respect to the following embodiments, employing the dual-delay-stage feedback architecture (also referred to herein as a dual-delay architecture) offers the ability to achieve a faster diffuse onset and therefore achieve a diffuse state with fewer feedback cycles. This is accomplished by virtue of the second-stage delay lines being positioned after the feedback matrix A 257, and through the reverberator specifications determining mₚᵣₑ along with the ratio m_{d,a}:m_{d,b}.

In some embodiments the reverberator parameter determiner 303 further comprises a pre-delay line length determiner 409 configured to determine the length mₚᵣₑ in samples of the pre-delay line z^{-m}^{ₚᵣₑ} 205. The pre-delay line length determiner 409 can be configured to determine the length mₚᵣₑ based on the pre-delay time tₚᵣₑ, if provided in the reverberation configuration specification 302, by converting tₚᵣₑ to samples. In some embodiments, if the pre-delay specification indicates that tₚᵣₑ denotes the time-of-arrival of the first-heard echo from the reverberator, then mₚᵣₑ can be adjusted by subtracting the length of the shortest first-stage feedback delay line,

$${min}_{d} {m}_{d , a} ,$$

in the case that the corresponding first echo at index d, a is not silenced, or the shortest of the aggregate lengths

$${min}_{d} {m}_{d} + {min}_{d} {m}_{d , a}$$

in the case that all first echoes are silenced.

In some other embodiments, the pre-delay specification may indicate that tₚᵣₑ denotes an onset timing of the diffuse state of the reverberator. In these embodiments the length mₚᵣₑ can be set such that the diffuse onset timing of the FN matches a desired tₚᵣₑ value. The diffuse onset timing of the FN can be estimated by any mixing time or diffuseness estimator, or predicted from analytic methods using the virtual space geometry specification provided in the reverberation configuration specification 302.

In some embodiments, the first echoes ToA specification may indicate, instead of specific numeric values, a target reflection order to be emulated by the first echoes of the FN, either individually or in aggregate. The first echoes can furthermore be referred to generally as ‘pseudo-reflection echoes’. Two examples of the design of pseudo-reflection echoes are described below.

In a first example that can be designated an ‘early reflection extension’, the first echoes ToA specification may indicate a target reflection order for which to emulate a characteristic time of arrival. For instance, the target order may be one greater than the order of reflections produced by reflection processor 851, thereby utilizing the reverberator first echoes as an “extension” of the reflection echoes. The characteristic ToA can be calculated based on the virtual space geometry specification, or a simplified (e.g. “shoebox”) approximation based on enclosing dimensions. From the geometric specification an image source model may be carried out, as detailed in the description of the reflection processor described herein in further detail later and J. B. Allen and D. A. Berkley, “Image method for efficiently simulating small-room acoustic,” J. Acoust. Soc. Am., vol. 65, pp. 943-950, April 1979 and J. Borish. “Extension of the image model to arbitrary polyhedra.” The Journal of the Acoustical Society of America 75.6 (1984): 1827-1836, to calculate the ToA of up to D image sources of the target reflection order, which then serve to inform the calculation of mₚᵣₑ and m_{d,a} as

$${m}_{TOA , d} = {m}_{pre} + {m}_{d , a} ,$$

where m_{TOA,d} is the time-of-arrival, in samples, of the dth selected image source of the target order.

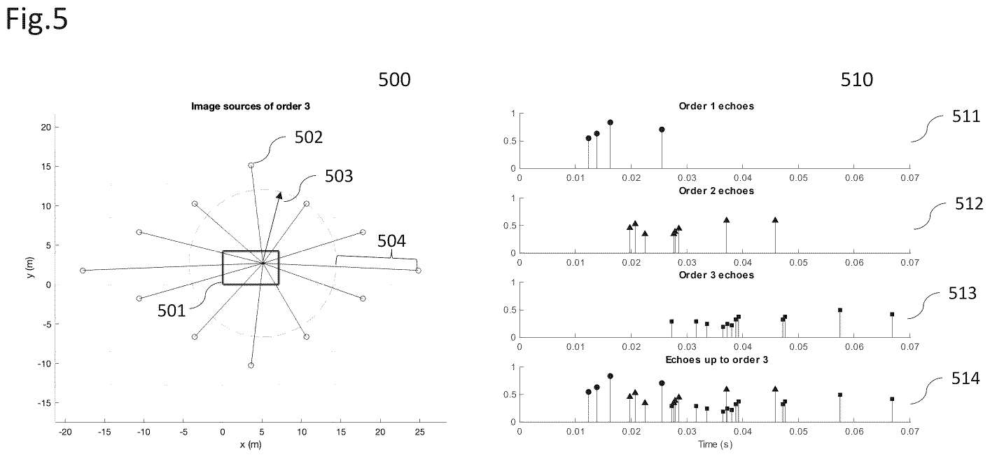

FIGS. 5a and 5b illustrate an example of multiple echo orders, in which the FIG. 5a shows a XY plane representation 500 of a virtual “shoebox” room 501 and its virtual image rooms in a grid like structure. Third-order image sources calculated by the image source method are depicted (one example image source indicated by item 502). The circle proscribed by a radius 503 may determine the time-equivalent value of tₚᵣₑ, and the remaining distance to each image source, exemplified by the distance 504, may correspond to the chosen values of m_{d,a} and m_{c,a} when converting the distances to time-of-flight and then to samples. In this example, FIG. 5b 510 shows ToAs (including tₚᵣₑ) for various echo orders. For example plot 511 shows order 1 echoes, 512 shows order 2 echoes, 513 shows order 3 echoes and 514 the combination of echoes up to (and including) order 3.

Thus in this example, plot 510 also indicates the broadband level of each image source which may serve as GEQ_{target,c}, in the determination of control gain filters GEQ_{ctrl,c} by the first echo gain parameter determiner 411, as described in further detail below.

Alternatively, the timing of the ‘reflection extension’ echoes can be modified to align in time with the approximate temporal density (or sparsity) of early reflections of the target order, with a corresponding approximation of amplitude density of image sources of the target order, through either a sampled average of the echograms of numerous source-receiver configurations, or by another statistical approximation.

In a second example that will be termed ‘early reflection augmentation’, the first echoes ToA specification may indicate multiple target reflection orders for which to emulate a characteristic time of arrival. For instance, the target orders may include multiple orders of reflection up to or exceeding the maximum order reproduced by reflection processor 851. These target ToAs may be calculated by the same means described in the ‘early reflection extension’ variant of the method. For example, in the case that D=C=15, 15 times-of-arrival, and corresponding levels to serve as GEQ_{target,c}, may be selectively or randomly chosen from the image source echogram, depicted for this example in plots 511, 512, and 513, corresponding to first-, second-, and third-order reflections respectively. The time for tₚᵣₑ may then be a value up to a minimum of the chosen ToAs, which is removed from the ToAs in the calculation of the resultant delay values m_{d,a} and m_{c,a}.

Any of the image sources not chosen for synthesis by first echoes can in some embodiments be synthesized by a reflection processor (as is discussed in further detail later). Thereby the first echoes of the reverberator may supplant echoes that may have otherwise been rendered by the reflection processor or add to a desired total number of (early) reflection echoes that is greater than the number that is produced by the reflection processor. Therefore, this method represents an ‘augmentation’ of early reflections.

In this example, the reflection echoes produced by the reflection processor and the ‘reflection augmentation echoes’ produced by first echoes of the reverberator, in aggregate, form the impulse response such as the one depicted in FIG. 5 plot 514 (a summation of all D reverberator outputs and reflection echoes).

The first echoes when employed as ‘reflection augmentation echoes’ do not display dynamic levels and dynamic directional encoding as reflection echoes from the reflection processor, and thus the example as shown in FIG. 5 plot 514 can be viewed as a ‘snapshot’ of the (summed) impulse response for a fixed or momentary source-receiver configuration.

In some embodiments, the reverberation ratio control filter parameter determiner 405 can be configured such that, when the filter GEQᵣₐₜᵢₒ 203 is applied to the input signal 201, the resultant reverberation has the desired energy ratio defined by the RDR(k). The input to the determiner can, in some embodiments, be the vector of reverberant-to-direct ratio (RDR) energy ratio values RDR(k) obtained by the reverberation configuration specification 302. The generated coefficients of GEQᵣₐₜᵢₒ output by the determiner can then be designed to match the reverberator spectrum energy to the target spectrum energy.

To do this, an estimate of the RDR of the reverberator output can be determined by the following procedure.

Firstly, rendering a unit impulse through the reverberator that has been configured with the parameters produced by the delay line lengths determiner 401, feedback attenuation filter parameters determiner 403, and tₚᵣₑ set to 0.

The input to the reverberator can be a buffer of zeros of a sufficient length to capture the reverberation tail, such as the maximum RT₆₀(k) among all frequency bands, with a unit impulse written to the head of the buffer.

Once rendered, the energy of the reverberator output is measured, along with that of the unit impulse, and the ratio of these energies is calculated. It is noted that the first echo modifier 299 is not employed during this determination. The procedure for measuring signal energy is detailed in the following.

The monophonic output signal sᵣₑᵥ(t), which is a function of time t, can be obtained by summation of the outputs of the feedback network 250. A FFT of length N_{FFT} is calculated over sᵣₑᵥ(t) and its magnitude spectrum can be obtained as

$$H ( {k}_{b} ) = abs ( FFT ( {s}_{rev} ( t ) ) .$$

Here, k_{b} are the FFT bin indices. The positive half spectral energy density is

$${S}_{rev} ( {k}_{b} ) = \frac{1}{{N}_{FFT}} * {H ( {k}_{b} )}^{2} ,$$

where the energy from the negative frequency indices k_{b} is added into the corresponding positive frequency indices k_{b}. The energy of a unit impulse can be calculated or obtained analytically and is denoted as Sᵤₙᵢₜ(k_{b}).

In some embodiments the energy of each band at index k are calculated as the positive half spectral energy density of the reverberator sᵣₑᵥ(k_{b}) and the positive half spectral energy density of the unit impulse Sᵤₙᵢₜ(k_{b}). Band energies can be calculated as

$$S ( k ) = {\sum }_{b = {b}_{low}}^{{b}_{high}} S ( {k}_{b} ) ,$$

where b_{low} and b_{high} are the lowest and highest bin indices belonging to band k, respectively. The band bin indices can be obtained by comparing the frequencies of the bins to the lower and upper frequencies of each band.

The reproduced RDR of the reverberator can then be obtained as

$${RDR}_{rev} ( k ) = {S}_{rev} ( k ) / {S}_{unit} ( k )$$

The target linear magnitude response for GEQᵣₐₜᵢₒ can be obtained as

$${g}_{{GEQ}_{ratio}} = sqrt ( RDR ( k ) ) / sqrt ( {RDR}_{rev} ( k ) )$$

where RDR(k) is the target linear RDR value from the reverberation configuration specification 302.

The target response control gain can then be determined by

$${γ}_{{GEQ}_{ratio}} ( k ) = 20 * {log}_{10} ( {g}_{{GEQ}_{ratio}} ) .$$

The RDR target response control gain can also be obtained directly in the logarithmic domain as

$${ℽ}_{{GEQ}_{ratio}} ( k ) = 10 * {log}_{10} ( RDR ( k ) ) - 10 * {log}_{10} ( {RDR}_{rev} ( k ) ) .$$

γ_{GEQ}_{ᵣₐₜᵢₒ}(k) is then provided to the graphic equalizer design routine, previously cited in the description of feedback attenuation filter parameters determiner 403, to produce filter coefficients for GEQᵣₐₜᵢₒ.

In some embodiments the reverberator parameter determiner 303 further comprises a first echo gain parameter determiner 411. The first echo gain parameter determiner 411 is configured to generate parameters used to configure the first echo modifier 299 of the reverberator to modify in amplitude or temporal alignment (according to the setting of first-stage delay lengths resulting from the procedure of the delay line length determiner 401) the first echoes from the output of the feedback network 250 of the reverberator.

The first echo modifier parameter determiner 411 is configured to generate or determine coefficients for the control line gain filters GEQ_{ctrl,c} according to the following methods.

On account of the matched delay lengths between delay lines z^{-m}^{_{c,a}} 252 and z^{-m}^{_{d,a}} 251, and the common graphic EQ design between filters GEQ_{d} 253 and GEQ_{ctrl,c} 255, the modifier echoes from the first echo modifier are coincident in time and phase with the corresponding first echoes of the FN to be modified. Consequently, the control line gain filters GEQ_{ctrl,c} 255 can be configured such that, when their output signals are combined with the FN output signals at adders 259, the first echoes from the FN are modified to a desired spectral contour and level.

For example, in a situation where first echoes from the FN are to be attenuated (or fully silenced), the first echo gain parameter determiner 411 is configured to produce filter coefficients for control gain filters GEQ_{ctrl,c} such that the filter gain response can be set in the range GEQ_{ctrl,c}∈[−GEQ_{d}, 0], in decibels, where a value of −GEQ_{d} is full attenuation (in other words silencing or “cancelling” the first echo from the dth channel of the FN), and value of 0 is no attenuation. This can be realized by the operation of summing at the adder 259_{d}.

This example enables an attenuation of first echoes and can be designated a ‘first echo attenuation’. As stated previously, indices c and d denote the unique pairings of channels to be summed at the adders 259. In this example, it is noted that, by nature of the band-wise attenuation filter design, the gains assigned to the control gain filters GEQ_{ctrl,c} may be specified for each band, in which case the first echo attenuation is frequency dependent. In this example, first echo gain parameter determiner 411 signals to the reverberator that signal junction 263 is used, instead of signal junction 262, such that the input to the control lines is the output of the GEQᵣₐₜᵢₒ filter.

In some embodiments, the reverberation configuration specification 302 does not directly specify gains of first echoes, but rather indicates to the first echo modifier gain determiner 411 that first echoes are to be modified to conform to an extension of or augmentation of the early reflection rendering.

For example, with respect to the ‘early reflection extension’ embodiments described above, the command gains of the (up to) D control line gain filters 255 can be set to

$${GEQ}_{ctrl , c} ( k ) = {GEQ}_{target , c} ( k ) - {GEQ}_{d} ( k ) - {GEQ}_{ratio} ( k ) ,$$

in decibels, where GEQ_{target,c}(k) is defined as an equalization profile of a reflection echo of an order greater than the order of reflection produced by reflection processor 851.

For example, where a reflection processor produces reflections up to order two, the frequency response GEQ_{target,c}(k) may be configured to target the equalization profile of a reflection of order three. These focused or target responses of the desired reflection order can be calculated by the same method as used in the image source method which is detailed in the description of reflection processor 851, or another suitable reflection-based absorption modeling.

In summary, GEQ_{target,c}(k) can be determined by factors such as attenuation due to air absorption over the distance traveled by the image source, and material absorption of reflected surfaces along the image source path, angle of incidence with these surfaces, and other factors.

In another example, with respect to the ‘early reflection augmentation’ embodiments, the command gains of the (up to) D control line gain filters 255 can be set to

$${GEQ}_{ctrl , c} ( k ) = {GEQ}_{target , c} ( k ) - {GEQ}_{d} ( k ) - {GEQ}_{ratio} ( k ) ,$$

in decibels, where GEQ_{target,c}(k) is defined as an equalization profile of C reflections of orders that are equal to one or more orders being reproduced by reflection processor. These defined equalization profiles can be calculated by the same means mentioned above with respect to the ‘early reflection extension’ embodiments. Thereby the first echoes of the reverberator may supplant or replace echoes that may have otherwise been rendered by the reflection processor or add to a desired total number of (early) reflection echoes that is greater than the number that is produced by the reflection processor.

In some embodiments therefore the first echoes employed as ‘reflection augmentation echoes’ do not display the dynamic levels and dynamic directional encoding of reflection echoes from the reflection processor.

Furthermore, for both of the reflection ‘extension’ and ‘augmentation’ examples, the pseudo-reflections are independent of the reverberant-to-direct energy ratio scaling of the reverberator, on account of the subtraction of GEQᵣₐₜᵢₒ(k) in the calculation of GEQ_{ctrl,c}(k). Both examples are therefore configured such that the input to the first echo modifier 299 is read from junction 262 instead of 263.

In some embodiments the control for the number of first echoes to be modified, up to the number D, can be signaled from a reflection rendering module. Generally, this will depend on the order of reflection echo rendering by the reflection processor 851. In the case of minimizing interference with early reflections by means of first echo suppression, the more reflection echoes that are rendered by the early reflection rendering module which temporally overlap with first echoes produced by the FN, the more first echoes are to be suppressed from the output of the FN.

In the early reflection extension example, the number of modified first echoes may correspond the number of reflection echoes of one order greater than the highest order of reflections produced by the reflection processor. In the early reflection augmentation example, the number of modified first echoes may correspond to the difference between a desired total number of early reflections and the number of reflections produced by the reflection processor.

In some embodiments, the number of echoes to be modified can be determined based on time regions in an impulse response which contain early reflections. For this purpose, reflection echoes can be synthesized by an early reflection synthesizer and the maximum and minimum time delays where these early reflections occur can be determined. The first echoes of the FN output falling within this same time delay range can then be modified.

In some other embodiments, echoes of the FN which interfere with one or more reflection echoes to be synthesized with the early reflection synthesizer can be suppressed.

An interference occurs when two signals interfere or overlap (or nearly overlap) in time. Such interference causes a reduction of the perceptual salience of the either signal, of which the reflection echo(es) is the more important signal in this situation. By reducing interference, the precise (early) reflections are perceived predominantly by the early reflection echo rendering path, while the diffuse (late) reverberation is perceived by the reverberator rendering path. The resulting rendered virtual audio scene is thus more readily perceived to vary depending on listener position on account of the controlled system response transition from reflection echoes to the onset of the late reverberation. Interfering first echoes can be determined, for example, as those which fall within a predetermined temporal span around time-adjacent reflection echoes.

Alternatively, or in addition, the number of echoes to be modified can be signaled as a bitstream parameter. Such embodiments can utilize analysis of the echo structures of the FN and early reflection renderer performed by the encoder device.

Alternatively, or in addition, the time range(s) of echoes in the FN output to be attenuated can be signaled as a bitstream parameter.

As shown in FIG. 3, the reverberator processing system 300 in some embodiments comprises a binaural renderer 309. The reverberant audio signals 210 are forwarded to the binaural renderer 309, which also receives directional configuration specification 312 as further inputs.

The binaural renderer 309 in some embodiments is configured to render the reverberant audio signals to reverberant binaural signals 314 which can, for example, be reproduced using headphones. These signals are perceived as surrounding and enveloping with acoustical characteristics according to reverberation configuration specification 302.

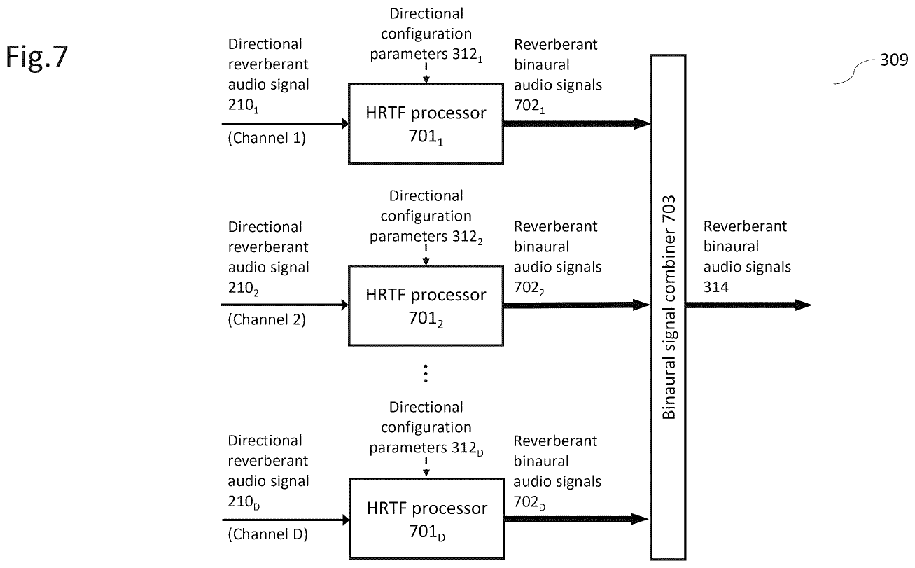

FIG. 7 shows schematically the binaural renderer 309 as shown in FIG. 3 in further detail. The input to the binaural renderer 309 is the directional reverberant audio signals 210_{d} sᵣₑᵥ(t, d) and the directional configuration 312 indicating rendering directions for each reverberant audio signal. In the example shown in FIG. 7 the binaural renderer 309 is organized on a channel-by-channel basis and there is one HRTF processor 701_{d} per reverberant audio channel. For example, a first channel HRTF processor 701₁ is configured to receive the directional reverberant audio signal 210₁ (channel one) and the directional configuration 312₁ associated with channel one. A second channel HRTF processor 701₂ is configured to receive the directional reverberant audio signal 210₂ (channel two) and the directional configuration 312₂ associated with channel two. Also shown is a Dth channel HRTF processor 701_{D} configured to receive the directional reverberant audio signal 210_{D} (channel D) and the directional configuration 312_{D} associated with channel D. Each of the HRTF processors can comprise a HRTF filter pair h_{bin}(m, i, d), where m is the time index of the filter coefficients, i=1, 2 is the index of the binaural channel, and d is the reverberator output channel index.

The operation of the dth HRTF processor 701_{d} is as follows. Using the HRTF filter pairs h_{bin}(m, i, d), reverberant binaural audio signals s_{bin}(t, i, d) 702_{d} can be determined for each channel of the directional reverberant audio signals 210_{d} by

$${s}_{bin} ( t , i , d ) = {h}_{bin} ( m , i , d ) ⊗ {s}_{rev} ( t , d )$$

where ⊗ denotes convolution (the filtering may also be performed in the frequency domain in some implementations instead of time-domain convolution).

The reverberant binaural audio signals s_{bin}(t, i, d) 702_{d} can then be passed to a binaural signal combiner 703.

The reverberant binaural audio signals s_{bin}(t, i, d) 702_{d} can then be combined across channels d in the binaural signal combiner 703 by

$${s}_{bin} ( t , i ) = {\sum }_{d} {s}_{bin} ( t , i , d )$$

yielding the reverberant binaural signals s_{bin}(t, i) 314 which is the output.

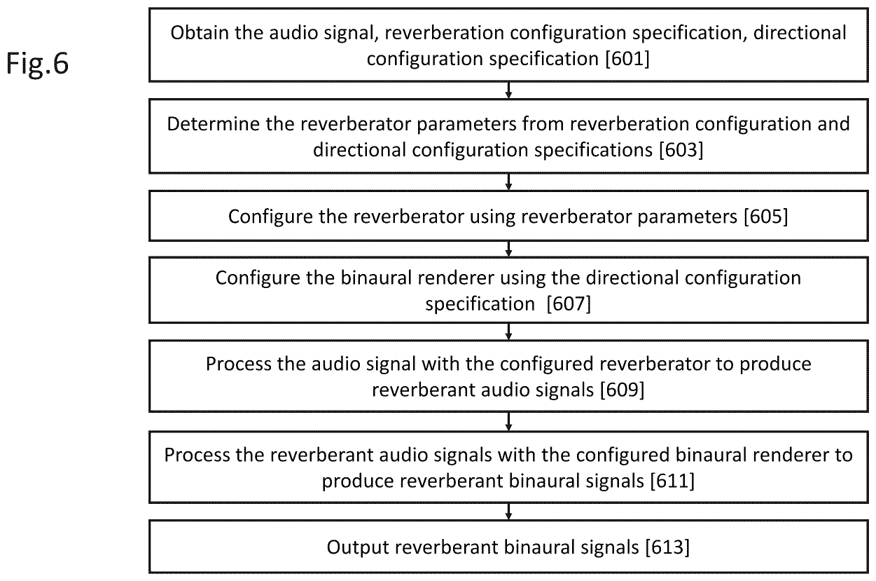

FIG. 6 shows an example flow diagram of the operations of the system shown in FIG. 3 with respect to the reverberator and the associated binaural renderer.

First, the audio signal 201, reverberation configuration specification 302, and directional configuration specification 312 are obtained as shown by 601.

Then, the reverberator parameters 304 are determined from the reverberation configuration specification 302 and directional configuration specification 312 inputs as shown by 603.

Then, the reverberator 200 is configured using reverberator parameters 304 as shown by 605.

Then, the binaural renderer 309 is configured using the directional configuration specification 312 as shown by 607.

Then, reverberant audio signals 210 are generated by processing the audio signal with the configured reverberator 200 as shown by 609.

Then, reverberant binaural signals 314 are rendered by processing the reverberated audio signals 210 with the configured binaural renderer 309 as shown by 611.

Then, reverberant binaural signals 314 are output as shown by 613.

A virtual audio scene rendering system 800, comprising the rendering system 300 shown in FIG. 3 is schematically depicted in FIG. 8. The virtual audio scene rendering system 800 can comprise a direct sound processor 861 configured to receive the audio signal 820 and generate direct audio signal 860 which are passed to a direct audio binaural renderer 869. The direct sound processor 861 renders the sound that directly reaches the listener without reflection or reverberation (in other words generating the direct sound portion 101 of the impulse response as shown in FIG. 1). In some embodiments the direct sound processor 861 is configured to apply distance gain attenuation (e.g. attenuation proportional to 1/r where r is the distance from the sound source to the listener) and air absorption filtering (which is a distance-dependent low-pass filter attenuating high frequencies).

The virtual audio scene rendering system 800 can furthermore comprise a direct audio binaural renderer 869 configured to receive the direct audio signals 860 and generate direct audio binaural audio signals 864 which are output.

The virtual audio scene rendering system 800 can comprise a reflection processor 851. With respect to the reverberator and the reflection processor these are configured to generate audio signals associated with echoes within the system. For example, the reflection processor is configured to produce a discrete number of echoes which are specular with regard to features and geometry of the modelled room and are correspondingly precise and independently varied in their arrival direction, intensity, and coloration, as characterizes early reflections in a room impulse response (in other words generating the directional early reflection portion 103 of the impulse response as shown in FIG. 1). The echoes produced by the reflection processor are accordingly referred to as reflection echoes. The reflection processor is external to and running in parallel with the reverberator which is configured to produce late reverberation.

The virtual audio scene rendering system 800 can furthermore comprise a reflection processor 851 configured to receive the audio signal 201 and generate reflection audio signals 850 which are passed to a reflection binaural renderer 859.

The virtual audio scene rendering system 800 can furthermore comprise a reflection binaural renderer 859 configured to receive the reflection audio signals 850 and generate early reflection binaural audio signals 854 which are output.

The virtual audio scene rendering system 800 can furthermore comprise the renderer system 300 shown in FIG. 3 wherein the audio signal 201 input is the combination 870 of the audio signals from each source shown as audio signal 8201 and 820ₙ.

It is noted that in the virtual audio scene rendering system 800, each source audio signal 820ₙ necessitates a separate instantiation of direct sound processor 861 (and processors following in series) and of reflection processor 851 (and processors following in series). By contrast, only a single instantiation of reverberation renderer system 300 is needed for any number of source audio signals 820ₙ by virtue of the signal adder 870 which combines all source signals into a single input to the reverberator 200.

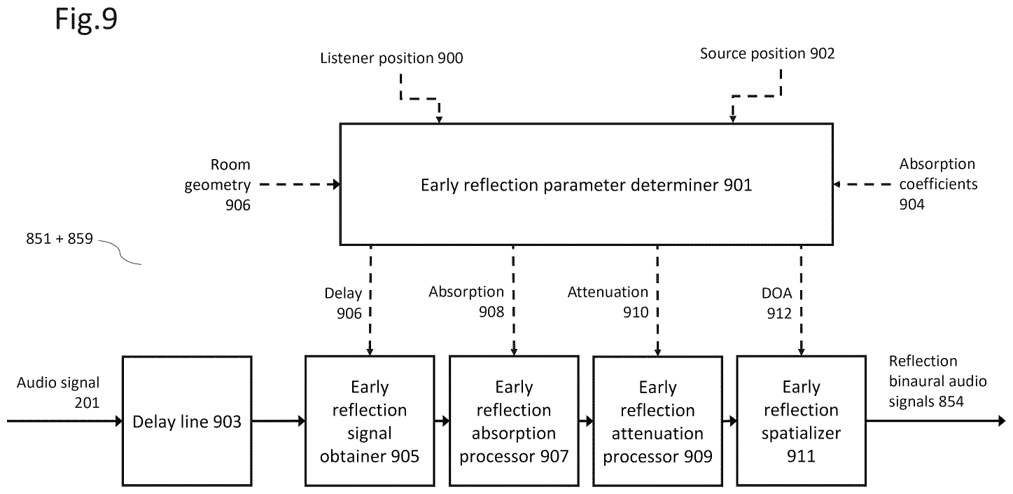

FIG. 9 shows schematically an example reflection processor 851 and the associated reflection binaural renderer 859 suitable for using along with the embodiments as shown in FIG. 8 and discussed herein in further detail. The example reflection processor 851 shows an example implementation and it would be understood that there are several ways to calculate or simulate early reflections which could be employed otherwise. For example an image source method can be employed such as detailed in J. B. Allen and D. A. Berkley, “Image method for efficiently simulating small-room acoustic,” J. Acoust. Soc. Am., vol. 65, pp. 943-950, April 1979 and J. Borish. “Extension of the image model to arbitrary polyhedra.” The Journal of the Acoustical Society of America 75.6 (1984): 1827-1836.

In the example early reflection renderer shown in FIG. 9, a reflection parameter determiner 901 is configured to receive the inputs of room geometry 906, listener position 900, source position 902, and absorption coefficients 904 and generate control parameters such as delay 906, absorption 908, attenuation 910 and direction of arrival (DoA) 912 and pass these to the processors described hereafter.

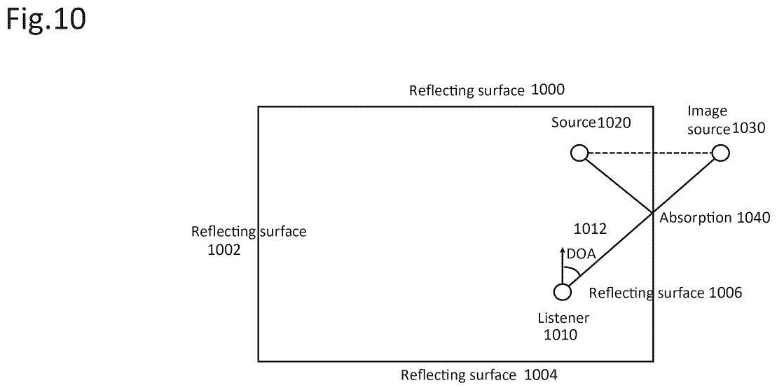

These parameters, such as delay 906, absorption 908, attenuation 910 and direction of arrival (DoA) 912, can be explained with respect to FIG. 10 where an example box or rectangular space is shown with reflecting surfaces 1000, 1002, 1004, 1006. Within the virtual acoustic space is the source 1020 and the listener 1010. The directions of a reflection between the source 1020 and the listener 1010 is shown where on the reflecting surface between the source 1020 and listener 1010 is a reflection and/or absorption point 1040. The mirroring of the source 1020 across the reflecting surface 1006 can be used to establish an image source 1030. The line connecting the image source 1030 to the listener 1010 can then be used to establish the reflection and/or absorption point 1040 and the DoA of the reflection with respect to the listener. The delay to be applied to synthesize a reflection is obtained based on the distance of the reflecting path (path from the image source to the listener which equals the length of the path from the source 1020 to the listener 1010). The absorption corresponds to the reflecting surface 1006 from which this sound trajectory is reflected (the reflection and/or absorption point 1040). The distance attenuation is set proportional to 1/r where r equals the length of the reflection path from the source to the listener. In addition, air absorption can be included in the attenuation of the image source. The DoA of a reflection is set based on the angle of arrival from the reflection point to the listener.

In some embodiments the input audio signal 201 is first fed into a delay line 903 which buffers audio signal samples and enables picking segments of past samples of the audio signal 201.

The reflection signal obtainer 905 can receive the output of the delay line 903 and the delay 906 parameter. The reflection signal obtainer is configured to obtain a past signal sample based on the delay 906 to obtain a delayed signal.

A reflection absorption processor 907 then can filter the selected past signal sample to apply an equalizer filter to model the frequency-dependent absorption data for the reflection to obtain delayed and absorption-filtered signal.

A reflection attenuation processor 909 can then attenuate the delayed and absorption-filtered signal by applying a 1/r attenuation and optionally air absorption to obtain delayed and absorption-filtered and attenuated signal.

Finally, a reflection spatializer 911 can be configured to spatialize the delayed and absorption-filtered and attenuated signal by HRTF filtering with a left and right HRTF filter corresponding to the desired DoA for this reflection to obtain a reverberant binaural signal 912 containing the synthesized reflection portion. In some situations, the reflection spatializer can be the binauralizer.

There are various ways to determine the image source parameters within the reflection parameter determiner 901. In the image source method, the sound source position is mirrored with respect to each reflecting surface of the room geometry to obtain image sources. In the example shown in FIG. 10, the mirroring is performed with regard to the rightmost reflecting surface 1006. The image source 1030 is located on a line perpendicular to reflecting surface 1006, at the same distance from it as the source 1020. A path from the image source 1020 to the listener 1010 indicates the distance traveled by the reflection. First order reflections reflect from a single wall whereas higher order reflections reflect from more than one wall. Higher order reflections can be obtained by using higher-order image sources which are mirrored by each of the reflecting surfaces in turn.

In some circumstances the output of the determiner is a list of image source positions such as [r₀, r₁, . . . , r_{I}, r_{1,1}, . . . , r_{1,I}, . . . r_{i,i}, . . . ], where r_{i,i}, . . . = [x_{i,i}, . . . , y_{i,i}, . . . , z_{i,i}, . . . ] are the coordinates an image source that in each order of reflection has been reflected by the ith subsequent surface.

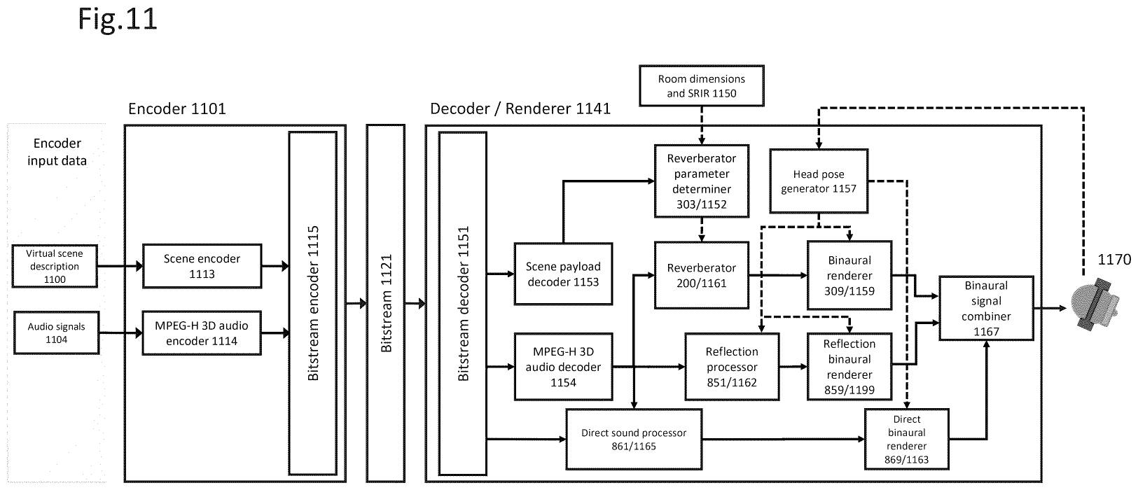

FIG. 11 shows schematically an example system where the embodiments are implemented in an encoder device 1101 which performs part of the functionality; writes data into a bitstream 1121 and transmits that for a renderer device 1141, which decodes the bitstream, performs reverberator processing according to the embodiments and outputs audio for headphone listening.

The encoder side 1101 of FIG. 11 can be performed on content creator computers and/or network server computers. The output of the encoder is the bitstream 1121 which is made available for downloading or streaming. The decoder/renderer 1141 functionality runs on an end-user-device, which can be a mobile device, personal computer, sound bar, tablet computer, car media system, home HiFi or theatre system, head mounted display for AR or VR, smart watch, or any suitable system for audio consumption.

The encoder 1101 is configured to receive the virtual scene description 1100 and the audio signals 1904. The virtual scene description 1100 can be provided in the MPEG-I encoder input format (EIF) or in another suitable format. Generally, the virtual scene description contains an acoustically relevant description of the contents of the virtual scene, and contains, for example, the scene geometry as a mesh or as voxels, acoustic materials, acoustic environments with reverberation parameters, positions of sound sources, and other audio element related parameters such as whether reverberation is to be rendered for an audio element or not. The encoder 1101 in some embodiments comprises a scene and reverberation payload encoder 1113 configured to generate reverberation parameters.

The encoder 1101 further comprises a MPEG-H 3D audio encoder 1114 configured to obtain the audio signals 1904 and MPEG-H encode them and pass them to a bitstream encoder 1115.

The encoder 1101 furthermore in some embodiments comprises a bitstream encoder 1115 which is configured to receive the output of the scene and reverberation payload encoder 1113 and the encoded audio signals from the MPEG-H encoder 1114 and generate the bitstream 1121 which can be passed to the bitstream decoder 1141. The bitstream 1121 in some embodiments can be streamed to end-user devices or made available for download or stored.

The decoder 1141 in some embodiments comprises a bitstream decoder 1141 configured to decode the bitstream.

The decoder 1141 further can comprise a scene payload decoder 1143 configured to obtain the encoded reverberation parameters and decode these in an opposite or inverse operation to the reverberation payload encoder 1113.

The reverberator parameter determiner 303/1142 is configured to receive the decoded reverberation configuration specification and room dimensions and spatial room impulse response (SRIR) 1140 information and generate the reverberator control parameters discussed herein. Note that in some embodiments no SRIR is received but reverberator parameters are obtained from the scene payload decoder 1143.

Furthermore, the head pose generator 1147 receives information from a head mounted device 1170 or similar and generates head pose information or parameters which can be passed to the binaural renderer 309/1159, the early reflection renderer 990/1162 and the direct sound binaural renderer 1163.

The decoder 1141 comprise MPEG-H 3D audio decoder 1144 which is configured to decode the audio signals and pass them to the reverberators 201/1161 and direct sound processing 1165.

The decoder 1141 furthermore comprises reverberators 201/1161 configured to implement a suitable reverberation of the audio signals from the MPEG-H 3D audio decoder 1144.

The output of the reverberator 201/1161 is configured to output reverberated audio based on the reverberator parameters to a binaural renderer 309/1159.

The decoder furthermore comprises an early reflection renderer 990/1162 configured to obtain the output of the MPEG-H 3D audio decoder 1144 and generate early reflections as described above and pass these to an early reflection binaural renderer 1199.

The decoder further comprises a binaural renderer 309/1159 configured to generate binaural reverberant audio signals from the output of the reverberators 201/1161.

The decoder further comprises an early reflection (ER) binaural renderer 1199 configured to generate binaural early reflection audio signals from the output of the early reflection renderer 990/1162.

Additionally, the decoder/renderer 1141 comprises a direct sound processor 1165 which is configured to receive the decoded audio signals and configured to implement any direct sound processing such as air absorption and distance-gain attenuation and which can be passed to a direct sound binaural renderer 1163 which with the head orientation determination (from a suitable sensor) can generate the direct sound component which with the reverberant component is passed to a binaural signal combiner 1167. The binaural signal combiner 1167 is configured to combine the direct, early reflection, and reverberant parts to generate a suitable output (for example for headphone reproduction).

Furthermore, in some embodiments the decoder comprises a head orientation determiner which passes the head orientation information to the head pose generator 1147.

As an alternative to transmitting reverberation parameters from the encoder to the renderer it is possible in some embodiments to transmit reverberator parameters in the bitstream. Reverberator parameters refer to the FDN parameters such as delay line lengths, attenuation filters, reverberation ratio control filters, and so on.

In some embodiments the assignment of reverberator outputs to loudspeaker channels happens during configuration of the reverberator. The assignment can be stored during configuration and provided to the reverberant signal router.

In some embodiments, the output is a multichannel loudspeaker setup (such as 5.1 or 7.1+4 multichannel loudspeaker setup). In that case, the spatial processing proposed in FIG. 8 can be modified by using the directions of the actual loudspeakers as the directional configuration and omitting the binaural renderers, and reproducing the reverberant audio signals from the corresponding loudspeakers of the loudspeaker setup. In the case of loudspeaker output, instead of binaural renderer 309/1159 in FIG. 11 there will be a loudspeaker renderer (or panner) which in the simplest case will pass through the output signals to a loudspeaker signal combiner which will replace the binaural signal combiner 1167. Correspondingly, the direct sound part and early reflection part are spatialized with a panner such as vector-base amplitude panning instead of the binaural processors.

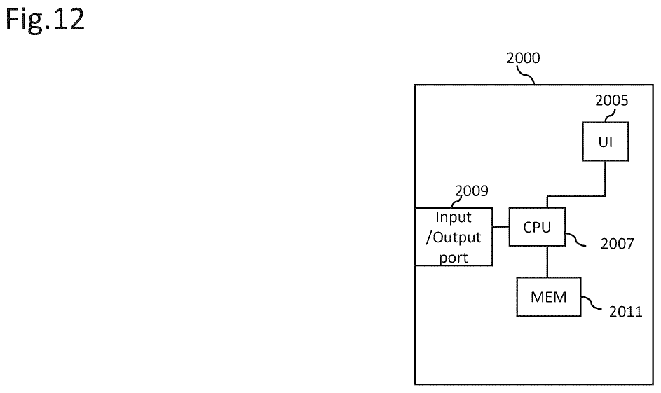

With respect to FIG. 12 an example electronic device which may be used as any of the apparatus parts of the system as described above. The device may be any suitable electronics device or apparatus. For example, in some embodiments the device 2000 is a mobile device, user equipment, tablet computer, computer, audio playback apparatus, etc. The device may for example be configured to implement the encoder or the renderer or any functional block as described above.

In some embodiments the device 2000 comprises at least one processor or central processing unit 2007. The processor 2007 can be configured to execute various program codes such as the methods described herein.

In some embodiments the device 2000 comprises a memory 2011. In some embodiments the at least one processor 2007 is coupled to the memory 2011. The memory 2011 can be any suitable storage means. In some embodiments the memory 2011 comprises a program code section for storing program codes implementable upon the processor 2007. Furthermore, in some embodiments the memory 2011 can further comprise a stored data section for storing data, for example data that has been processed or to be processed in accordance with the embodiments as described herein. The implemented program code stored within the program code section and the data stored within the stored data section can be retrieved by the processor 2007 whenever needed via the memory-processor coupling.

In some embodiments the device 2000 comprises a user interface 2005. The user interface 2005 can be coupled in some embodiments to the processor 2007. In some embodiments the processor 2007 can control the operation of the user interface 2005 and receive inputs from the user interface 2005. In some embodiments the user interface 2005 can enable a user to input commands to the device 2000, for example via a keypad. In some embodiments the user interface 2005 can enable the user to obtain information from the device 2000. For example, the user interface 2005 may comprise a display configured to display information from the device 2000 to the user. The user interface 2005 can in some embodiments comprise a touch screen or touch interface capable of both enabling information to be entered to the device 2000 and further displaying information to the user of the device 2000. In some embodiments the user interface 2005 may be the user interface for communicating.

In some embodiments the device 2000 comprises an input/output port 2009. The input/output port 2009 in some embodiments comprises a transceiver. The transceiver in such embodiments can be coupled to the processor 2007 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example, in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The input/output port 2009 may be configured to receive the signals.

In some embodiments the device 2000 may be employed as at least part of the renderer. The input/output port 2009 may be coupled to headphones (which may be a headtracked or a non-tracked headphones) or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus for applying reverberation to at least one audio signal, the apparatus comprising at least one processor and at least one memory storing instructions that, when executed by the at least one processor, cause the system at least to perform:
obtaining the at least one audio signal;
obtaining at least three reverberation parameters based on obtaining reverberation configuration information and directional configuration information;
controlling a reverberator using the at least three reverberation parameters for providing a reverberant audio signal using the at least one audio signal, based on the at least three reverberation parameters, the reverberant audio signal comprising at least a late reverberation part;
processing at least a portion of the reverberant audio signal, the portion of the reverberant audio signal at least partially interfering with a reflection audio signal; and
generating a binaural output audio signal, the binaural output audio signal comprising the processed reverberant audio signal.

2. The apparatus as claimed in claim 1, further caused to perform determining the reflection audio signal from the at least one audio signal, wherein the reflection audio signal comprises at least an early reflections part.

3. The apparatus as claimed in claim 2, caused to perform determining the reflection audio signal from the at least one audio signal further caused to perform processing the at least one audio signal to generate the reflection audio signal.

4. The apparatus as claimed in claim 2, caused to perform generating the binaural output audio signal is further caused to perform combining the processed reverberant audio signal and the reflection audio signal.

5. The apparatus as claimed in claim 1, further caused to perform providing a direct audio signal based on processing the at least one audio signal, wherein the binaural output audio further comprises the direct audio signal.

6. The apparatus as claimed in claim 5, caused to perform providing the direct audio signal based on processing the at least one audio signal is further caused to perform applying to the at least one audio signal at least one of:
distance gain attenuation;
air absorption filtering, and
directional reproduction processing.

7. The apparatus as claimed in claim 1, wherein the reverberant audio signal further comprises at least one first echo, wherein the portion of the reverberant audio signal which at least partially interferes with the reflection audio signal is the at least one first echo.

8. The apparatus as claimed in claim 1, caused to perform processing at least a portion of the reverberant audio signal, the portion of the reverberant audio signal at least partially interfering with the reflection audio signal is further caused to perform one of:
determining the portion of the reverberant audio signal at least partially interfering with a reflection audio signal based on an analysis of the reverberant audio signal and the reflection audio signal; or
determining the portion of the reverberant audio signal based on a user input defining the at least partially interfering portion of the reverberant audio signal.

9. The apparatus as claimed in any of claim 1, wherein the reverberation configuration comprises at least one of:
at least one late reverberation time;
at least one first echo arrival time;
at least one first echo level.

10. The apparatus as claimed in any of claim 1, caused to perform controlling the reverberator using the at least three reverberation parameters for providing the reverberant audio signal using the at least one audio signal caused to perform:
controlling the reverberator comprising:
a gain stage associated with late reverberation;
a first stage delay line and a second stage delay line respectively for providing at least one first echo arrival time and for providing at least one parameter associated with the late reverberation, wherein the reverberator is configured to provide an output using the at least one audio signal based on the gain stage, the first stage delay line and the second stage delay line;
providing at least one control line comprising at least one delay line and a gain filter, wherein the at least one delay line is associated with the first stage delay line and the gain filter is associated with the gain stage, and wherein the at least one delay line and the gain filter are configured based on the at least three reverberation parameters so as to cause an output from the at least one control line using the at least one audio signal.

11. The apparatus as claimed in claim 10, caused to perform providing the reverberant audio signal using the at least one audio signal is further caused to perform generating the at least one reverberated audio signal based on a combination of the at least one reverberator and the output of the at least one control line.

12. The apparatus as claimed in claim 10, wherein a timing and density of at least a first portion of the at least one reverberated audio signal output by the at least one reverberator is defined by the at least three reverberation parameters.

13. The apparatus as claimed in any of claim 10, caused to perform obtaining at least three reverberation parameters is further caused to perform obtaining:
the first of the at least three reverberation parameters as at least one reverberation time for controlling the first stage delay line and the second stage delay line;
the second of the at least three reverberation parameters as at least one first-echoes time-of-arrival for controlling the first stage delay line and the at least one control line delay line; and
the third of the at least three reverberation parameters as at least one first-echoes level for controlling the at least one control line gain filter.

14. The apparatus as claimed in claim 13, wherein the reverberator further comprises a feedback attenuation filter associated with the first stage delay line, wherein the at least one reverberation time is further for controlling the at least one feedback attenuation filter.

15. The apparatus as claimed in claim 14, wherein the reverberator further comprises a feedback matrix.

16. The apparatus as claimed in claim 15, caused to perform controlling the reverberator based on the at least three reverberation parameters is further caused to perform:
applying the first stage delay line and the feedback attenuation filter preceding the feedback matrix to the at least one audio signal;
applying the feedback matrix to an output of one of the first set of delay lines or the at least one feedback attenuation filter; and
applying the second stage delay line succeeding the feedback matrix to an output of the feedback matrix, an output of the second stage delay line providing at least one input to the feedback network, wherein the reverberator is configured to generate at least two successive echoes.

17. The apparatus as claimed in claim 1, caused to perform processing at least a portion of the reverberant audio, the portion of the reverberant audio signal at least partially interferes with a reflection audio signal is further caused to perform at least partially suppressing or otherwise modifying in amplitude a first echo of the at least one reverberant audio signal such that the at least one reverberant signal comprises reverberations which minimally interfere with or otherwise compliment the at least one reflection echoes.

18. The apparatus as claimed in any of claim 1, wherein the reverberation configuration comprises at least one of:
reverberation time;
reverberant-to-direct ratio;
diffuse-to-source energy ratio;
pre-delay time;
a first echo time-of-arrival specification;
a first echo frequency contour specification;
a virtual space geometry specification.

19. The apparatus as claimed in claim 1, wherein the directional configuration comprises a spherical design such as a t-design, Lebedev grid, or other suitable uniform spherical layout with D points representing rendering directions.

20. A method for applying reverberation to at least one audio signal, the method comprising:
obtaining the at least one audio signal;
obtaining at least three reverberation parameters based on obtaining reverberation configuration information and directional configuration information;
controlling a reverberator using the at least three reverberation parameters for providing a reverberant audio signal using the at least one audio signal, based on the at least three reverberation parameters, the reverberant audio signal comprising at least a late reverberation part;
processing at least a portion of the reverberant audio signal, the portion of the reverberant audio signal at least partially interfering with a reflection audio signal; and
generating a binaural output audio signal, the binaural output audio signal comprising the processed reverberant audio signal.
